(19) United States
(12) Patent Application Publication
(10) Pub. No.: US 2020/0164572 A1
(43) Pub. Date: May 28, 2020

(54) THREE-DIMENSIONAL ARTICLE AND METHOD OF MAKING A THREE-DIMENSIONAL ARTICLE

(71) Applicant: 3M INNOVATIVE PROPERTIES COMPANY, St. Paul, MN (US)

(72) Inventors: Jeffrey N. Bartow, West St. Paul, MN (US); Carsten Franke, St. Paul, MN (US); Alexander J. Huffman, St. Paul, MN (US)

(21) Appl. No.: 16/627,533

(22) PCT Filed: Jun. 29, 2018
(86) PCT No.: PCT/US2018/040234

§ 371 Date: Dec. 30, 2019

Related U.S. Application Data
(60) Provisional application No. 62/527,376, filed on Jun. 30, 2017.

(51) Int. Cl. B29C 64/165; B33Y 10/00; B33Y 70/10; B33Y 50/02; B29C 64/393; B29C 64/245; B29C 64/264; B33Y 30/00

(52) U.S. Cl. CPC B29C 64/165; B33Y 10/00; B33Y 70/10; B33Y 30/00; B29C 64/393; B29C 64/245; B29C 64/264; B33Y 50/02

(57) ABSTRACT

A method includes obtaining a composition (1016) disposed on a surface of a substrate (1010), irradiating a first portion (1017a) of the composition for a first irradiation dosage, and irradiating a second portion (1017b) of the composition for a second irradiation dosage. The composition (1016) includes fluoropolymer particles and a binder material that is polymerizable upon exposure to radiation. The first portion (1017a) and the second portion (1017b) are adjacent to or overlapping with each other, and the first irradiation dosage and second irradiation dosage are different. Irradiating the first and second portions of the composition (1016) polymerizes the binder material and forms a three-dimensional article (1017) having a first portion (1017a) and a second portion (1017b) on the surface of the substrate (1010). The first portion (1017a) and second portion (1017b) of the three-dimensional article have different thicknesses in an axis normal to the surface of the substrate (1010). Three-dimensional articles are also described. The article (1017) can be. for example, a structured film.

### CROSS-REFERENCE TO RELATED APPLICATION

This application claims priority to U.S. Provisional Application No. 62/527,376, filed Jun. 30, 2017, the disclosure of which is incorporated by reference in its entirety herein.

### BACKGROUND

Fluoropolymers are widely used as raw materials and can be useful for articles requiring at least one of low friction properties, inertness to chemicals, or heat resistance.

It is sometimes difficult to make fluoropolymer articles using conventional manufacturing methods. For example, PTFE and copolymers of tetrafluoroethylene with a relatively high melt viscosity cannot be shaped by conventional melt processing techniques such as extrusion, injection molding, or blow molding.

Additive manufacturing has been proposed for certain fluoropolymers. Int. App. Pub. No. WO2007/133912 (Audenaert et al.) describes a laser sintering process for certain fluoropolymers. CN 105711104, published Jun. 29, 2016, and CN103709737, published Apr. 9, 2014, both also describe laser sintering processes and apparatuses, and polytetrafluoroethylene is mentioned. U.S. Pat. No. 7,569,273 (Bredt et al.) describes using an ink-jet printer to print a fluid onto a particulate polymer to form an adhesive. Polyvinylidene fluoride is said to be useful as the particulate polymer.

### SUMMARY

In one aspect, the present disclosure provides a method of making a three-dimensional article. The method includes obtaining a composition disposed on a surface of a substrate, irradiating a first portion of the composition through the substrate for a first irradiation dosage, and irradiating a second portion of the composition through the substrate for a second irradiation dosage. The substrate is transparent to the actinic or particle radiation. The composition includes fluoropolymer particles and a binder material that is polymerizable upon exposure to radiation. The first portion and the second portion of the compositions are adjacent to or overlapping with each other, and the first irradiation dosage is different from the second irradiation dosage. It should be understood that both the first irradiation dosage and the second irradiation dosage are non-zero dosages. Irradiating the first portion of the composition and the second portion of the composition polymerizes the binder material and forms a three-dimensional article having a first portion and a second portion on the surface of the substrate. The first portion of the three-dimensional article has a different thickness in an axis normal to the surface of the substrate than the second portion of the three-dimensional article.

In another aspect, the present disclosure provides a method of making a three-dimensional article. The method includes obtaining a composition disposed on a surface of a substrate and irradiating at least a portion of the composition through the substrate for an irradiation dosage. The composition includes fluoropolymer particles and a binder material that is polymerizable upon exposure to actinic or particle radiation. The substrate is transparent to the actinic or particle radiation. Irradiating the portion of the composition polymerizes the binder material and forms at least a portion of a three-dimensional article, wherein the portion of the three-dimensional article has a fraction of the thickness of the portion of the composition, wherein the fraction of the thickness is less than 1. In the portion of the three-dimensional article, the binder material in contact with the substrate is polymerized.

In another aspect, the present disclosure provides a three-dimensional article made by such methods.

It is worth noting that upon polymerization of the binder material in the aforementioned methods, the fluoropolymer particles are bound within the polymerized volume and become immobile.

In another aspect, the present disclosure provides a structured film including a non-melt-processable fluoropolymer. The structured film includes a first portion and a second portion having different heights.

Typically and advantageously, the present disclosure not only provides three-dimensional articles having a wide variety of shapes and varied thicknesses, but also can provide three-dimensional articles having multiple different thicknesses and structures in the same three-dimensional article. The method according to the present disclosure can typically and advantageously provide three-dimensional articles made from non-melt-processable fluoropolymers having shapes not easily attainable by skiving. Skiving is not readily capable of forming three-dimensional having complex shapes having thickness variations, for example, structured films.

In contrast to layer-by-layer building that is common with additive manufacturing techniques, polymerization and the resulting building of parts using the method of the present disclosure generally occurs continuously for the duration of the irradiation.

In this application, terms such as “a”. “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and integral and non-integral values between the endpoints unless otherwise stated (e.g. 1 to 5 includes 1, 1.5, 2, 2.75, 3, 3.80, 4, and 5).

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

The term “perfluoroalkyl group” includes linear, branched, and/or cyclic alkyl groups in which all C—H bonds are replaced by C—F bonds.

The phrase “interrupted by one or more —O— groups”, for example, with regard to an alkyl, alkylene, or arylalkylene refers to having part of the alkyl, alkylene, or arylalkylene on both sides of the one or more —O— groups. An example of an alkylene that is interrupted with one —O— group is —CH₂—CH₂—O—CH₂—CH₂—.

The term “aryl” as used herein includes carbocyclic aromatic rings or ring systems, for example, having 1, 2, or 3 rings, optionally containing at least one heteroatom (e.g., O, S, or N) in the ring, and optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, oxazolyl, and thiazolyl. “Arylalkylene” refers to an “alkylene” moiety to which an aryl group is attached. “Alkylarylene” refers to an “arylene” moiety to which an alkyl group is attached.

The term “structured film” refers to a film with other than a planar or smooth surface.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### BRIEF DESCRIPTION OF THE DRAWINGS

FIG. 1A is a schematic top view of an example of a three-dimensional article made according to the method of the present disclosure:

FIG. 1B is a schematic cross-sectional view of an example of a three-dimensional article made according to the method of the present disclosure;

FIG. 1C is a schematic perspective view of an example of a three-dimensional article made according to the method of the present disclosure;

FIG. 2 is a photograph of a three-dimensional article made in Example 1;

FIG. 3 is a photograph of a three-dimensional article made in Example 2;

FIG. 4 is a schematic perspective view of another example of a three-dimensional article made according to an embodiment of the method of the present disclosure;

FIG. 5 is a schematic perspective view of an example of a structured film according to the present disclosure and/or made according to the method of the present disclosure;

FIG. 6 is a schematic cross-sectional view of an embodiment of the method according to the present disclosure;

FIGS. 7A and 7B are schematic cross-sectional views of other embodiments of the method according to the present disclosure;

FIG. 8 is a schematic cross-sectional view of yet another embodiment of the method according to the present disclosure;

FIG. 9 is a schematic cross-sectional view of still another embodiment of the method according to the present disclosure;

FIG. 10 is a schematic cross-sectional view of an apparatus useful for practicing an embodiment of the method according to the present disclosure;

FIG. 11 is a schematic cross-sectional view of an apparatus useful for practicing another embodiment of the method according to the present disclosure;

FIG. 12 is a schematic cross-sectional view of an apparatus useful for practicing yet another embodiment of the method according to the present disclosure,

FIG. 13 is a schematic cross-sectional view of an apparatus useful for practicing still another embodiment of the method according to the present disclosure;

FIG. 14 is a schematic cross-sectional view of an apparatus useful for practicing an additional embodiment of the method according to the present disclosure;

FIG. 15 is a schematic cross-sectional view of an apparatus useful for practicing another additional embodiment of the method according to the present disclosure;

FIG. 16 illustrates an embodiment of a system for carrying out the method of the present disclosure;

FIG. 17 illustrates another embodiment of a system for carrying out the method of the present disclosure;

FIG. 18 is a schematic cross-sectional view of an embodiment of a washing station useful with any of the apparatuses shown in FIGS. 10 to 15;

FIG. 19 is a schematic cross-sectional view of another embodiment of a washing station useful with any of the apparatuses shown in FIGS. 10 to 15; and

FIG. 20 is a schematic top view of an embodiment of an oven useful with any of the apparatuses shown in FIGS. 10 to 15.

### DETAILED DESCRIPTION

The method of the present disclosure includes obtaining a composition disposed against a surface of a substrate, irradiating a first portion of the composition for a first irradiation dosage, and irradiating a second portion of the composition for a second irradiation dosage. The first portion and the second portion are adjacent to or overlapping with each other and the first irradiation dosage and the second irradiation dosage are not the same. It should be understood that the first irradiation dosage and second irradiation dosage are non-zero dosages. The method forms an integral three-dimensional article having a variable thickness in an axis normal to the surface of the substrate.

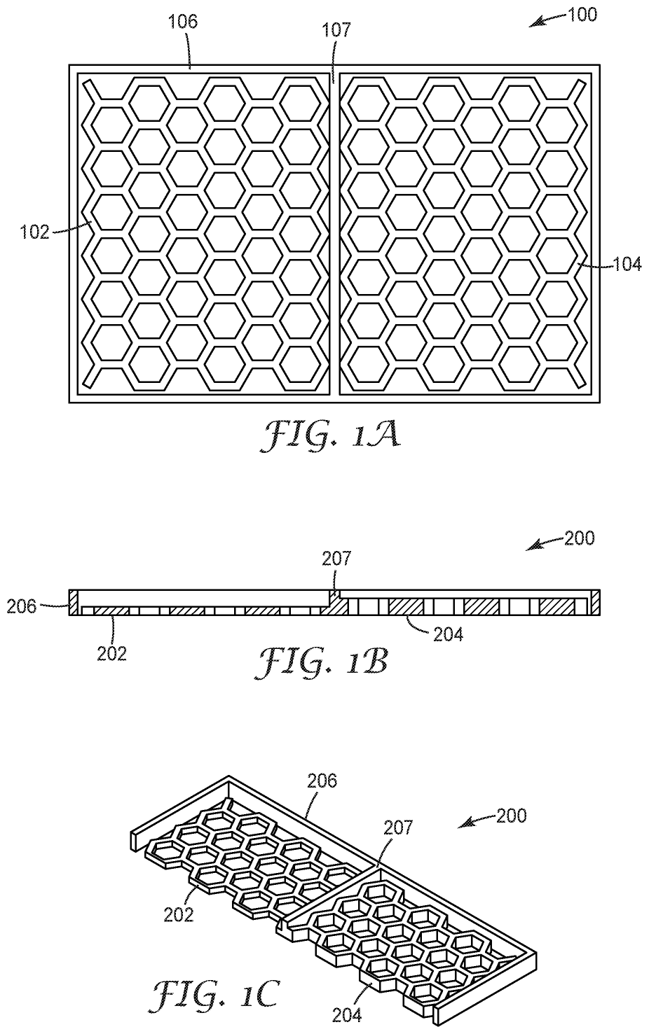

Referring to FIG. 1, an embodiment of a three-dimensional article made by a method according to the first aspect is illustrated. The three-dimensional article 100 includes a first array of interconnected hexagons 102, an adjacent second array of interconnected hexagons 104, and a frame 106 that has a plurality of walls surrounding each of the first array of interconnected hexagons 102 and the second array of interconnected hexagons 104. The frame 106 includes a frame wall 107 that separates the first array of interconnected hexagons 102 from the second array of interconnected hexagons 104. The three-dimensional article 100 may be composed of any composition disclosed herein.

The method of making the three-dimensional article 100 includes obtaining a composition disposed on a surface of a substrate and irradiating a first portion of the composition for a first irradiation dosage. The composition includes fluoropolymer particles and a binder material that is polymerizable upon exposure to actinic or particle radiation. The first portion may be defined by an exposure image that includes a pattern provided by, for example, a computer controlled digital light processor, liquid crystal display (LCD), laser scanning system, or a photomask. The pattern can block radiation from passing through all of the regions of the exposure image except for the desired pattern (e.g., as with a combination of light source and photomask) or provides radiation in the shape of the pattern (e.g., as with a laser or an array of pixels). When the exposure image includes a photomask, the photomask can be positioned adjacent to the substrate. Conveniently, the substrate can be transparent to radiation, and irradiation can be carried through the substrate. In some embodiments, for example, when the exposure image includes radiation in the shape of the pattern (e.g., via digital projection or laser scanning), the exposure image can be made by positioning an irradiation source to direct radiation towards the composition. When the first portion of composition is irradiated for the first irradiation dosage, binder is at least partially polymerized in the shape of the first portion of the three-dimensional article. Generally, the greater the irradiation dosage, the further into the composition (normal to the substrate surface) the irradiation travels, and the thicker the resulting portion of the three-dimensional article.

The method of making the three-dimensional article further includes irradiating a second portion of the composition for a second irradiation dosage. To irradiate the second portion of the composition, a second exposure image is used. The second exposure image can be provided by any of the methods as discussed above with respect to the first exposure image. To make a three-dimensional article shown in FIGS. 1A to 1C, the second exposure image includes a select portion of the features included in the first exposure image to provide the second array of interconnected hexagons 204, the frame 206 having a plurality of walls surrounding the second array of interconnected hexagons 204, and the frame wall 207. When the second portion of composition is irradiated for the second irradiation dosage, binder is at least partially polymerized in the shape of the second portion of the three-dimensional article. In the illustrated embodiment, irradiating the second portion results in an increase in the thickness of all of the areas of the three-dimensional article except for the first array of hexagons 202, due to the second exposure image overlapping all of the pattern of the first exposure image aside from the part of the image that makes the first array of hexagons 202. The difference in thickness results from the first irradiation and the second irradiation because the first array of hexagons 202 will have been exposed to an irradiation dosage that is less than the total irradiation dosage to which the remainder of the composition was exposed.

In some embodiments of the method, including embodiments to produce the three-dimensional article shown in FIGS. 1A to 1C, the method further includes irradiating a third portion of the composition for a third irradiation dosage. To irradiate the third portion of the composition, a third exposure image is used. The third exposure image can be provided by any of the methods as discussed above with respect to the first exposure image. To make a three-dimensional article shown in FIGS. 1A to 1C, the third exposure image includes a select portion of the features included in the first and second exposure images to provide the frame 206 having a plurality of walls and the frame wall 207. When the third portion of composition is irradiated for the third irradiation dosage, binder is at least partially polymerized in the shape of the third portion of the three-dimensional article. In the illustrated embodiment, irradiating the third portion results in an increase in the thickness of the frame 206 and frame wall 207, due to the third exposure image overlapping the frame areas of the pattern of the first exposure image and of the second exposure image. The difference in thickness results from the first irradiation, the second irradiation, and the third irradiation because the frame 206 and the frame wall 207 will have been exposed to an irradiation dosage that is greater than the total irradiation dosage to which the remainder of the composition was exposed.

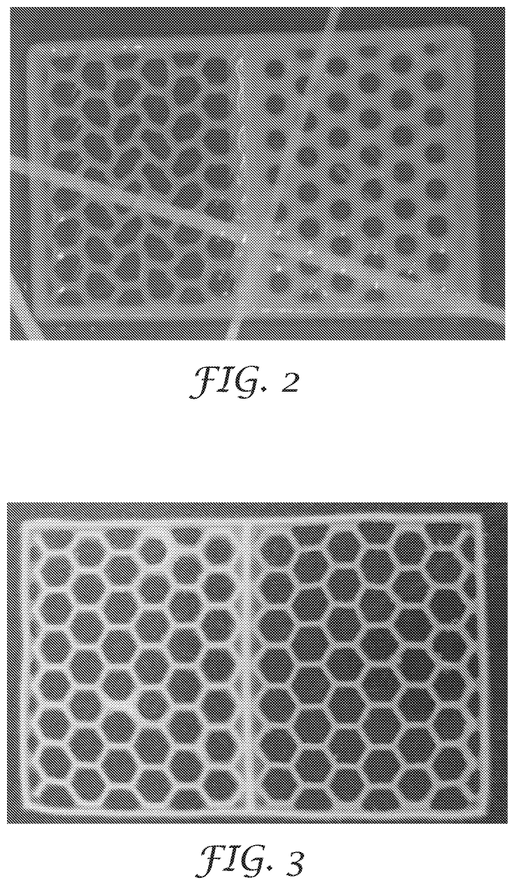

Photographs of three-dimensional articles having the same pattern as illustrated in FIG. 1A are shown in FIGS. 2 and 3. FIGS. 2 and 3 show the three-dimensional articles of Examples 1 and 2, below. The deformation in the hexagon pattern on the left side of FIG. 2 is the result of stresses from partial removal of solvent contained in the compositions. Once all the solvent is removed, the expected shape of the hexagons is achieved with little to no distortion. The three-dimensional articles shown in FIGS. 2 and 3 can also be considered structured films.

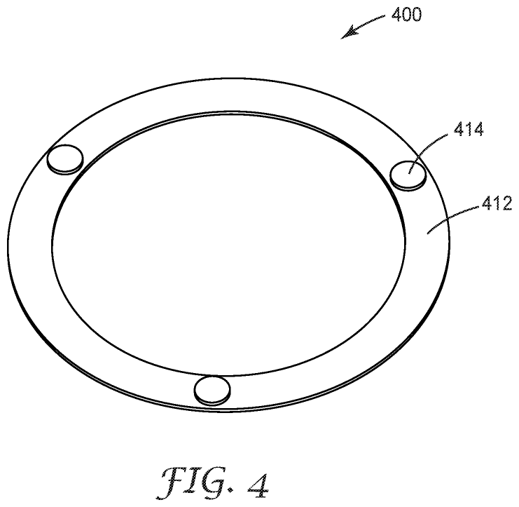

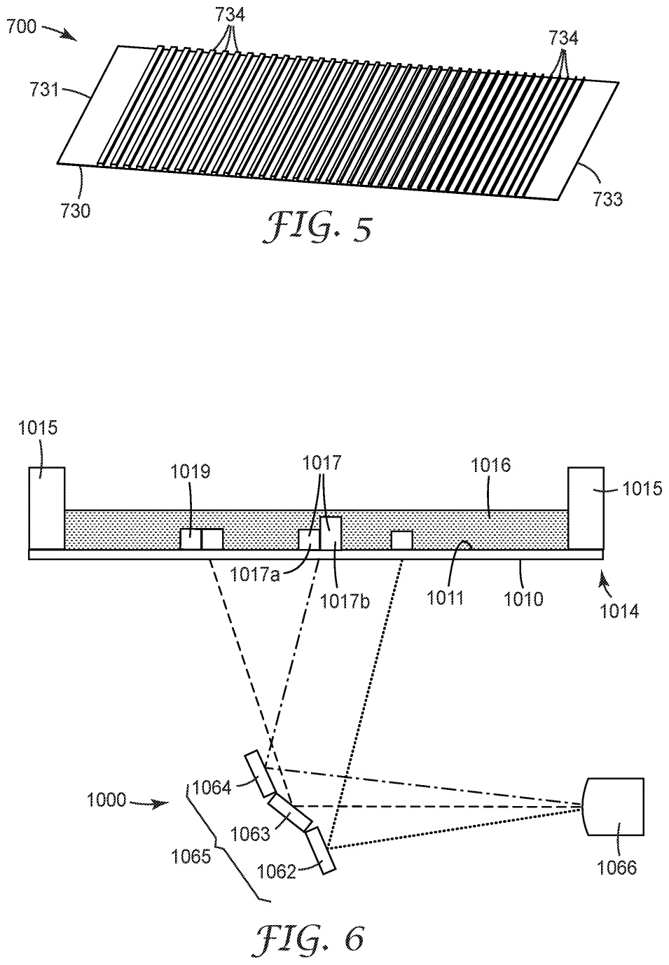

Referring to FIG. 4, another example of a three-dimensional article made according to the method of the present disclosure is shown. The three-dimensional article 400 includes a first portion in the form of a ring 412 and a second portion in the form of a plurality of raised areas 414. The three-dimensional article 400 can be formed from a radiation-polymerizable composition using two different irradiation dosages. The ring 412 of the three-dimensional article 400 is integral with each of the plurality of raised areas 414, and is formed from the first irradiation dosage. The thickness of the plurality of raised areas 414 represents the distance normal to the surface of the substrate that the radiation-polymerizable composition was polymerized in the second irradiation dosage. The positions of the raised areas 414 is achieved based on the pattern that is irradiated during the second irradiation dosage.

Referring to FIG. 5, another example of a structured film according to the present disclosure and/or made according to the method of the present disclosure is shown. The structured film 700 includes a backing 730 and a plurality of spaced apart ridges 734, wherein the width of the spaced apart ridges 734 decreases from one end 731 of the backing 730 to the other end 733 of the backing 730. For instance, the widths of the spaced apart ridges 734 may vary from about 550 micrometers down to about 40 micrometers. The structured film 700 may be formed from a radiation-polymerizable composition using two different irradiation dosages. The backing 730 of the structured film 700 is integral to all of the plurality of ridges 734, and is formed from the radiation-polymerizable composition during the first irradiation dosage. The thickness of the plurality of spaced apart ridges 734 represents the distance normal to the surface of the radiation-transparent substrate that the radiation-polymerizable composition was polymerized in the second irradiation dosage. The widths of the plurality of ridges 734 is achieved based on the pattern that is irradiated during the second irradiation dosage.

Advantageously, the method of the present disclosure provides the capability to manufacture individual three-dimensional articles having a number of unique shapes by employing adaptable radiation sources, from which the bounds and dosage of the radiation determine the specific shape of an individual three-dimensional article. Digital light processors, laser scanning devices, and liquid crystal displays, for example, can all be controlled to change the area and intensity of the radiation that causes curing of the radiation-polymerizable composition. If an identical shape needs to be produced repeatedly, a photomask or series of photomasks could be more cost effective than other methods of achieving a pattern of irradiation. Suitable types of radiation for the method according to the present disclosure include any radiation that can cause polymerization such as actinic and particle radiation (e.g., ultraviolet light, visible light, X rays, gamma radiation, ion beam, electronic beam, or other high-energy electromagnetic radiation).

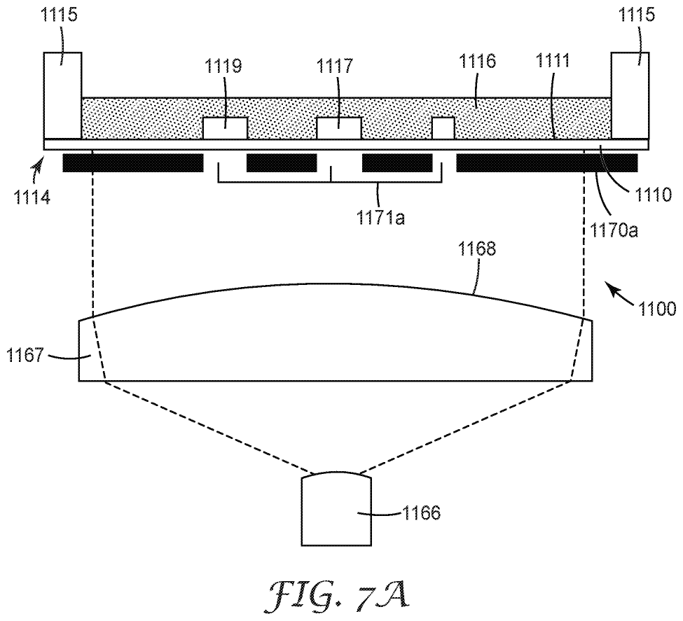

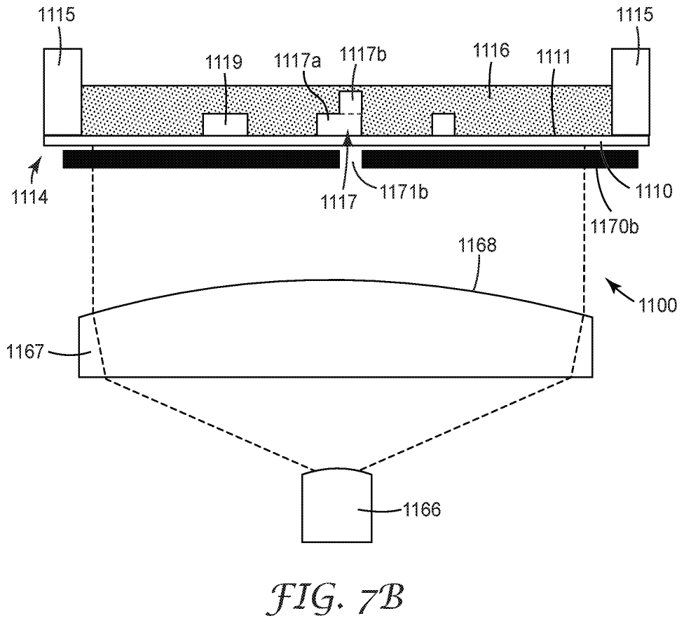

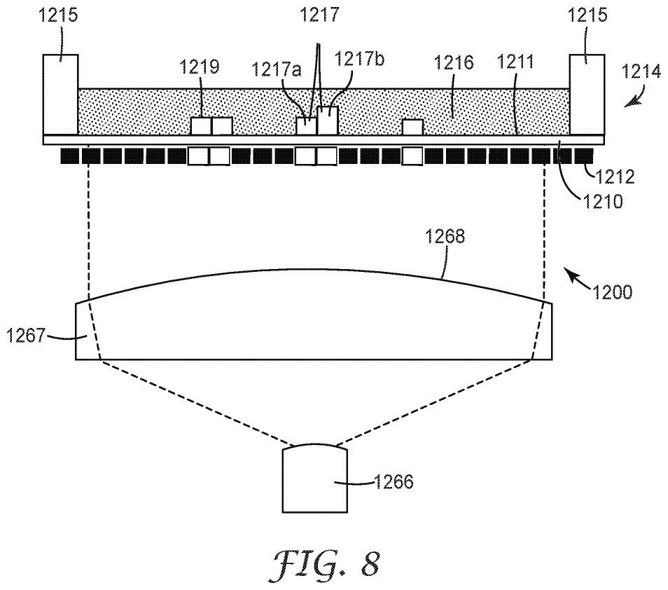

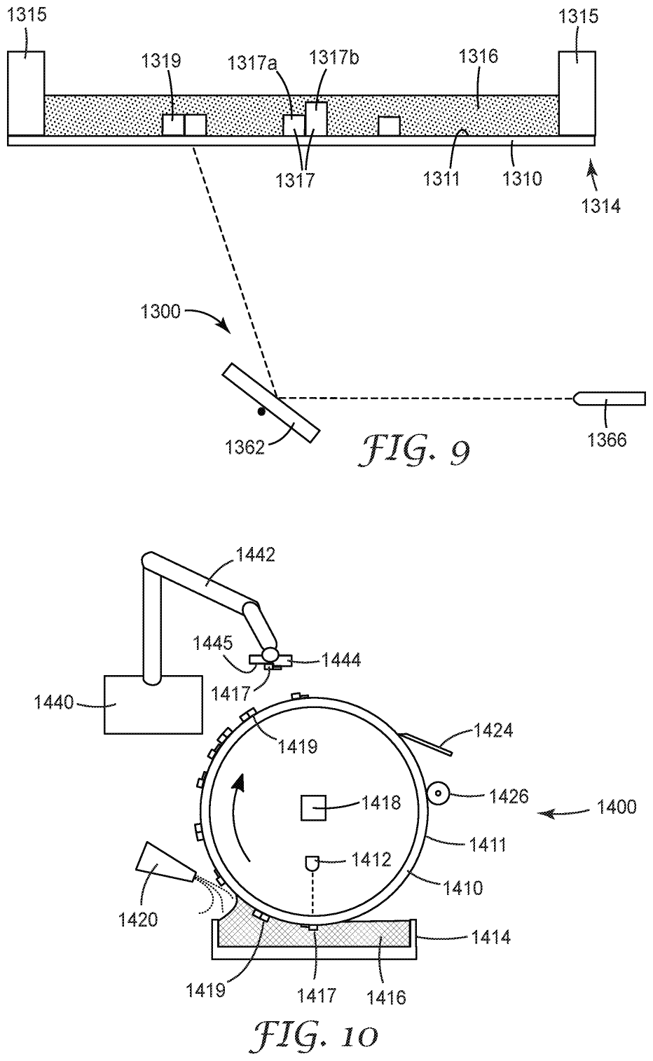

In some embodiments, the radiation is provided by a digital light processor with a light emitting diode (LED), a digital light processor with a lamp, a laser scanning device with a laser, a liquid crystal display (LCD) panel with a backlight, a photomask with a lamp, or a photomask with an LED. Examples of suitable lamps include an incandescent lamp, a flash lamp, a low pressure mercury lamp, a medium pressure mercury lamp, and a microwave driven lamp. The three-dimensional article can include variations in index of refraction as a result of the radiation source. For example, observation of a cross-section of the three-dimensional articles prepared according to the method of the present disclosure may reveal variations in index of refraction due to corresponding variations in cure provided by the discrete LEDs, or the digital light processor pixels, or the laser passes, or the LCD pixels, or the greyscale of the photomask. Some embodiments of the method according to the present disclosure are provided in FIGS. 6, 7A, 7B, 8, and 9. A schematic is provided in FIG. 6 of a digital light processor with an LED or lamp, schematics are provided in FIGS. 7A and 7B of a photomask with a lamp or LED, a schematic is provided in FIG. 8 of an LCD panel with a backlight, and a schematic is provided in FIG. 9 of a laser scanning device with a laser.

Referring to FIG. 6, an embodiment of a method according to the present disclosure is shown. In the illustrated embodiment, a radiation-polymerizable composition 1016 is disposed against a surface 1011 of substrate 1010. The method includes irradiating a first portion of the radiation-polymerizable composition 1016 through the radiation-transparent substrate 1010 for a first irradiation dosage (e.g., using irradiation source 1000 comprising an LED or lamp 1066 and a digital light processor 1065 comprising a plurality of reflectors 1062, 1063, and 1064). The method further includes irradiating a second portion of the radiation-polymerizable composition 1016 through the radiation-transparent substrate 1010 for a second irradiation dosage. The first portion and the second portion are adjacent to or overlapping with each other and the first irradiation dosage and the second irradiation dosage are not the same. The method forms a three-dimensional article 1017 having a variable thickness (e.g., 1017a as compared to 1017b) in an axis normal to the surface 1011 of the radiation-transparent substrate 1010.

Referring again to FIG. 6, a schematic is provided of an irradiation source 1000 for use in some embodiments of the method of the present disclosure, comprising a digital light processor 1065 with an LED or a lamp 1066 (1066 represents either an LED or a lamp). The digital light processor 1065 includes a plurality of individually movable reflectors, such as first reflector 1062, second reflector 1063, and third reflector 1064. Each reflector is positioned at a specific angle to direct irradiation from the LED or lamp 1066 towards a predetermined location of a composition 1016 disposed on a major surface 1011 of a radiation-transparent substrate 1010. In use, the intensity and duration of the irradiation from the LED or lamp 1066 will impact the depth of cure (e.g., polymerization) of the composition 1016 in a direction normal to the major surface 1011 of the substrate 1010 upon formation of one or more three-dimensional articles 1017 and 1019. For instance, one portion 1017b of three-dimensional article 1017 has a greater thickness than another portion 1017a of the same three-dimensional article 1017. This may be achieved by irradiating the portion 1017b with a greater dosage than the portion 1017a is irradiated. In contrast, three-dimensional article 1019 has a single thickness across its width due to receiving the same dosage across its width. A benefit of employing a digital light processor is that the individual reflectors are readily adjustable (e.g., using computer controls) to change the irradiation location and dosage and thereby the shape of the resulting formed three-dimensional articles, as needed without requiring a significant equipment alteration. Digital light processors are well-known in the art, for instance and without limitation, the apparatuses described in U.S. Pat. Nos. 5,658,063 (Nasserbakht), 5,905,545 (Poradish et al.), 6,587,159 (Dewald), 7,164,397 (Pettitt et al.), 7,360,905 (Davis et al.), 8,705,133 (Lieb et al.), and 8,820,944 (Vasquez). Suitable digital light processors are commercially available, such as from Texas Instruments (Dallas, Tex.) under the trade designation “DLP”. As indicated above, either an LED or a lamp may be employed with a digital light processor. Suitable lamps may include a flash lamp, a low pressure mercury lamp, a medium pressure mercury lamp, and/or a microwave driven lamp. The skilled practitioner can select a suitable LED or lamp light source to provide the radiation required to initiate polymerization for a particular polymerizable composition, for instance, the UV LED CBT-39-UV, available from Luminus Inc. (Sunnyvale, Calif.).

Referring to FIGS. 7A and 7B, another embodiment of a method according to the present disclosure is shown. FIGS. 7A and 7B schematically illustrate an irradiation source 1100 comprising at least one photomask 1170a and 1170b with an LED or a lamp 1166 (1166 represents either an LED or a lamp), for use in some embodiments of the method of the present disclosure. A lens 1167 having a convex surface 1168 is employed with the LED or lamp 1166 to diffuse the irradiation across at least a portion of the one or more photomasks 1170a and 1170b. As shown in FIG. 7A, a first photomask 1170a is employed to direct irradiation from the LED or lamp 1166 towards a predetermined location of a composition 1116 disposed on a major surface 1111 of a radiation-transparent substrate 1110. The first photomask 1170a includes a plurality of portions 1171a through which irradiation can be directed to cure the composition 1116. In use, the intensity and duration of the irradiation from the LED or lamp 1166 will impact the depth of cure (e.g., polymerization) of the composition 1116 in a direction normal to the major surface 1111 of the substrate 1110 upon formation of one or more three-dimensional articles 1117 and 1119. Referring now to FIG. 7B, a second photomask 1170b is shown in which one portion 1171b is provided through which irradiation can be directed to further cure the composition 1116. In the illustrated embodiment, the second portion 1117b of three-dimensional article 1117 has a greater thickness than a first portion 1017a of the same three-dimensional article 1117. The second portion 1117b has a greater thickness than the first portion 1117a due to being irradiated twice; once using the first photomask 1170a and once using the second photomask 1170b; resulting in irradiation of the portion 1117b with a greater dosage than the portion 1117a. In contrast, three-dimensional article 1119 has a single thickness across its width due to receiving the same dosage across its width by exposure to irradiation through just the first photomask 1170a. While the photomasks in FIGS. 7A and 7B are shown as having opaque and transparent portions, the skilled practitioner will appreciate that photomasks including greyscale may be employed to achieve gradients in cure in different locations of the composition. Suitable photomasks are commercially available, for instance, NanoSculpt Photomasks from Infinite Graphics (Minneapolis, Minn.). Similar to using a digital light processor, either an LED or a lamp may be employed with a photomask.

Referring to FIG. 8, another embodiment of a method according to the present disclosure is shown. FIG. 8 schematically illustrates an irradiation source 1200 comprising a digital photomask 1212 (e.g., a LCD with a backlight 1266), wherein the back light comprises an LED or a lamp 1266 (1266 represents either an LED or a lamp), for use in some embodiments of the method of the present disclosure. A lens 1267 having a convex surface 1268 is employed with the backlight 1266 to diffuse the irradiation across at least a portion of the digital photomask 1212. In use, the intensity and duration of the irradiation from the backlight 1266 will impact the depth of cure (e.g., polymerization) of the composition 1216 in a direction normal to the major surface 1211 of the substrate 1210 upon formation of one or more three-dimensional articles 1217 and 1219. In the illustrated embodiment, the second portion 1217b of three-dimensional article 1217 has a greater thickness than a first portion 1217a of the same three-dimensional article 1217. This may be achieved by irradiating the second portion 1217b with a greater dosage than the first portion 1217a is irradiated. In contrast, three-dimensional article 1219 has a single thickness across its width due to receiving the same dosage across its width. A benefit of employing a digital photomask is that the individual pixels are readily adjustable (e.g., using computer controls) to change the irradiation location and dosage and thereby the shape of the resulting formed three-dimensional article, as needed without requiring a significant equipment alteration. Suitable LCDs are commercially available, for instance, the LCD LQ043TIDG28, available from Sharp Corporation (Osaka, Japan).

Referring to FIG. 9, another embodiment of a method according to the present disclosure is shown. FIG. 9 schematically illustrates an irradiation source 1300 comprising a laser scanning device 1362 with a laser 1366, for use in some embodiments of the method of the present disclosure. The laser scanning device 1362 includes at least one individually movable mirror. Each mirror is positioned at a specific angle to direct irradiation from the laser 1366 towards a predetermined location of a composition 1316 disposed on a major surface 1311 of a radiation-transparent substrate 1310. In use, the intensity and duration of the irradiation from the laser 1366 will impact the depth of cure (e.g., polymerization) of the composition 1316 in a direction normal to the major surface 1311 of the substrate 1310 upon formation of one or more three-dimensional articles 1317 and 1319. For instance, one portion 1317b of three-dimensional article 1317 has a greater thickness than another portion 1317a of the same three-dimensional article 1317. This may be achieved by irradiating the portion 1317b with a greater dosage than the portion 1317a is irradiated. In contrast, three-dimensional article 1319 has a single thickness across its width due to receiving the same dosage across its width. A benefit of employing a laser scanning device is that the individual mirror(s) are readily adjustable (e.g., using computer controls) to change the irradiation location and dosage and thereby the shape of the resulting formed three-dimensional articles, as needed without requiring a significant equipment alteration. Suitable laser scanning devices are commercially available, such as the JS2808 Galvanometer Scanner from Sino-Galvo (Beijing) Technology Co., LTD. (Beijing, China). The skilled practitioner can select a suitable laser to provide the radiation required to initiate polymerization for a particular polymerizable composition, for instance, the CUBE 405-100C Diode Laser System from Coherent Inc. (Santa Clara, Calif.).

In any of the embodiments illustrated in FIGS. 6 to 9, the radiation-transparent substrate is a floor of a container and the irradiation is directed through the floor from below the floor. For instance, referring again to FIG. 6, a container 1014 is provided comprising side walls 1015 and floor (i.e., radiation-transparent substrate) 1010. The radiation-polymerizable composition 1016 is disposed on a major surface 1011 of the floor 1010 of the container 1014, and the irradiation is directed through the floor 1010 from the irradiation source 1000 located below the floor 1010. Similarly, referring to FIGS. 7A and 7B, a container 1114 is provided comprising side walls 1115 and floor (i.e., radiation-transparent substrate) 1110; referring to FIG. 8, a container 1214 is provided comprising side walls 1215 and floor (i.e., radiation-transparent substrate) 1210; and referring to FIG. 9, a container 1314 is provided comprising side walls 1315 and floor (i.e., radiation-transparent substrate) 1310. While in the illustrated embodiments, the substrate is transparent to radiation, and irradiation is directed through the substrate, it is also possible to position the radiation sources (e.g., 1000, 1200, and 1300) to direct radiation to the opposite side of the composition if desired. In some embodiments, including the embodiments illustrated in FIGS. 6 to 9, the container includes no second substrate opposite the radiation-curable substrate. That is, the radiation-polymerizable composition is contained on at most three sides, and is exposed to the atmosphere (e.g., air).

In some embodiments, including any of the embodiments illustrated in FIGS. 6 to 9, the method further comprises removing at least a portion of the composition comprising the fluoropolymer particles and the binder material in which the binder material is not polymerized after the irradiating. The composition is typically in contact with the three-dimensional articles. Removing composition that has not been polymerized after the irradiating may involve the use of gravity, a gas, a vacuum, a fluid, or any combination thereof, such as pouring off at least a portion of the composition remaining in contact with the three-dimensional articles after the irradiating, or blowing off at least a portion of the composition using an air knife or nozzle. Optionally, a suitable fluid for removing excess composition includes a solvent (e.g., water). It is typically desirable to remove composition from being in contact with the three-dimensional article to maintain the desired shape and size of the three-dimensional article. In some embodiments, including any of the embodiments illustrated in FIGS. 6 to 9, the three-dimensional article can also be further dried and heated to remove solvent and/or thermally degrade the binder material and/or fuse the fluoropolymer particles, for example, as described in further detail below. This may be carried out, if desired, after removing the three-dimensional articles from the substrate.

In some embodiments, the method of the present disclosure further comprises moving at least one of the substrate or the radiation source and subsequently irradiating a third portion of the composition for a third irradiation dosage. The third radiation dosage may be the same as one of the first or second irradiation dosage, or the third radiation dosage may be different from both the first and second irradiation dosages. These embodiments may be useful, for examples, for making structured films or other web constructions with varying heights.

Referring to FIG. 10, another embodiment of a method according to the present disclosure is shown. FIG. 10 schematically illustrates an apparatus 1400 for use in some embodiments of the method of the present disclosure. The apparatus includes a radiation-transparent substrate 1410 having a major surface 1411 and an irradiation source 1412 configured to direct radiation through the radiation-transparent substrate 1410 at predetermined dosages at predetermined locations. The apparatus 1400 further includes a means for depositing 1414 a composition 1416 onto the major surface 1411 of the radiation-transparent substrate 1410 and a means for conveying 1418 the radiation-transparent substrate 1410 or the irradiation source 1412 with respect to each other. In the illustrated embodiment, the means for depositing 1414 a composition 1416 onto the major surface 1411 of the radiation-transparent substrate 1410 comprises an open container holding a volume of the composition 1416 positioned adjacent to the substrate 1410 such that a portion of the major surface 1411 of the substrate 1410 is in contact with the composition 1416. The contact deposits the composition 1416 on the major surface 1411 of the substrate 1410, then as the means for conveying 1418 the substrate 1410 rotates, the composition 1416 continues to be deposited on the portions of the major surface 1411 of the substrate 1410 that come into contact with the composition 1416 held in the container 1414.

Optionally, an air knife 1420 configured to remove at least a portion of the non-polymerized composition 1416 from the substrate 1410 is provided with the apparatus. Air knives are well known in the art and use compressed air to blow off contaminants, excess materials, etc. from a product or apparatus.

The schematic of the apparatus 1400 shown in FIG. 10 includes the radiation-transparent substrate 1410 in the form of a cylinder. The means for depositing 1414 a composition 1416 on a cylindrical substrate 1410 may comprise rotating the cylinder through a volume of the composition 1416 to apply the composition 1416 on the major surface 1411 of the substrate 1410. Advantageously, it is not always necessary to have strict control over the thickness of a composition that is deposited on the substrate because the irradiation dosage from the irradiation source is selected to polymerize a predetermined shape and size of the composition, as opposed to polymerizing through an entire thickness of the composition regardless of its particular depth. The radiation source may be any of those described above. The composition 1416 that has been irradiated at least partially polymerizes, forming at least one three-dimensional article, such as the article 1417 and article 1419. At least one of the three-dimensional articles (e.g., 1417) has a variable thickness in an axis normal to the radiation-transparent substrate 1410.

The schematic of the apparatus 1400 further comprises a mechanism 1440 configured to remove one or more three-dimensional articles 1417 as they pass by the mechanism. For instance, the mechanism can be a robotic mechanism having a movable arm 1442 and a replaceable end effector 1444 configured to remove one or more three-dimensional articles 1417 from the radiation-transparent substrate 1410. In the embodiment shown in FIG. 10, the end effector 1444 comprises a major surface 1445 configured to be an inverse of the shape of an upper major surface of the three-dimensional article 1417. Once a three-dimensional article (e.g., article 1417 and article 1419) reaches the mechanism 1440 via rotation of the radiation-transparent substrate 1410, the article (1417, 1419) is transferred from the major surface 1411 of the substrate 1410 to a major surface 1445 of the end effector 1444 of the mechanism 1440. The mechanism 1440 is typically configured to place the three-dimensional article 1419 in a location separate from the apparatus 1400, such as on another substrate, on a device, on a release liner, or in a storage container. In a separate location, the three-dimensional article can also be further dried and heated (e.g., to thermally degrade the binder material and/or fuse the fluoropolymer particles as described in further detail below). In some embodiments, the apparatus 1400 further comprises a scraper 1424 configured to scrape the substrate 1410 and/or a tacky roller 1426 configured to clean the substrate 1410.

Referring to FIG. 11, another embodiment of a method according to the present disclosure is shown. FIG. 11 schematically illustrates an apparatus 1500 for use in some embodiments of the method of the present disclosure. The apparatus includes at least two rollers 1552 and 1518 (at least one of which is configured to convey a radiation-transparent substrate 1510), and an irradiation source 1512 configured to direct radiation through the radiation-transparent substrate 1510 at predetermined dosages at predetermined locations. The apparatus 1500 further includes a means for depositing 1514 a composition 1516 onto a major surface 1511 of the radiation-transparent substrate 1510 and a means for conveying the radiation-transparent substrate 1510 or the irradiation source 1512 with respect to each other. The means for depositing 1514 comprises a container configured to dispense the composition 1516 as a pool on the major surface 1511 of the substrate 1510. The radiation-transparent substrate 1510 is often a consumable material obtained separately from the apparatus as opposed to being a component of the apparatus. Optionally, an air knife 1520 configured to remove at least a portion of the non-polymerized composition 1516 from the substrate 1510 where one or more three-dimensional articles 1517 and 1519 are formed is provided with the apparatus 1500.

In use the apparatus shown in FIG. 11 can be operated as follows: Roller 1518 drives a web of the radiation-transparent substrate 1510 through a plurality of rollers 1550a and 1550b that form a containment area to hold the composition 1516 supplied by the means for depositing 1514 the composition 1516 on the major surface 1511 of the substrate 1510. The means for depositing 1514 in this embodiment is a container disposed above the radiation-transparent substrate 1510. An irradiation source 1512 directs radiation through the radiation-transparent substrate 1510 at one or more predetermined dosages at one or more predetermined locations. The composition 1516 that has been irradiated at least partially polymerizes, forming at least one three-dimensional article 1517. One portion of three-dimensional article 1517 has a greater thickness than another portion of the same three-dimensional article 1517. This may be achieved by irradiating one portion of the article 1517 with a greater dosage than another portion is irradiated. In contrast, three-dimensional article 1519 has a single thickness across its width due to receiving the same dosage across its width. As the substrate 1510 continues to be driven from an unwind roller 1552 to the wind roller 1518 as shown in FIG. 1, an air knife 1520 directs air towards the major surface 1511 of the substrate 1510 to assist in removing at least a portion of the composition 1516 remaining on the major surface 1511 of the substrate 1510 that was not polymerized to form a three-dimensional article. Any excess of composition 1516 removed here can then be returned to the containment area defined by the plurality of rollers 1550a and 1550b. Once a formed three-dimensional article (e.g., the three-dimensional article 1517 and the three-dimensional article 1519) reaches the wind roller 1518, the web of radiation-transparent substrate 1510 is wound up. In some embodiments, the web may optionally be passed through a wash station 1535 and an oven 1537, for example, to remove solvent and/or heat the articles to thermally degrade the binder material and/or fuse the fluoropolymer particles, for example, as described in further detail below. In some embodiments, the three-dimensional articles 1517, 1519 can be removed from the radiation-transparent web before they are dried or heated in a separate location. If the three-dimensional article is a continuous web, the three-dimensional web (e.g., structured film) can be removed from the radiation-transparent substrate and dried, heated, and/or wound up in a toll in the same web process or in one or more separate web processes (not shown).

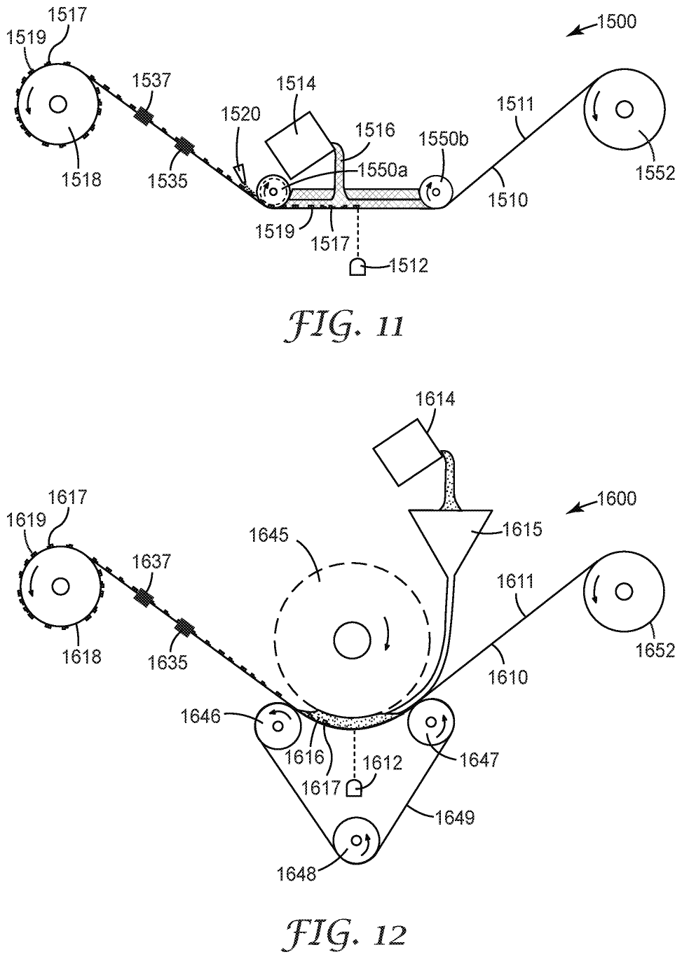

Referring to FIG. 12, another embodiment of a method according to the present disclosure is shown. FIG. 12 schematically illustrates an apparatus 1600 for use in some embodiments of the method of the present disclosure. The apparatus includes at least two rollers 1652 and 1618, at least one of which is configured to convey a radiation-transparent substrate 1610 relative to the irradiation source 1612, which is configured to direct radiation through the radiation-transparent substrate 1610 at predetermined dosages at predetermined locations. The apparatus 1600 further includes a means for depositing 1614 a composition 1616 onto a major surface 1611 of the radiation-transparent substrate 1610. The radiation-transparent substrate 1610 is often a consumable material obtained separately from the apparatus as opposed to being a component of the apparatus. The means for depositing 1614 comprises a container configured to dispense the composition 1616 through a funnel 1615 and as a pool on the major surface 1611 of the substrate 1610. The apparatus further includes a dam roller 1645 comprising a pair of spaced apart edges (not shown) configured to contact the radiation-transparent substrate 1610 and define a containment area between the edges to provide space for the pool of composition 1616 disposed on the radiation-transparent substrate 1610.

A further means may be provided to contact the dam roller 1645 with the radiation-transparent substrate 1610 to assist in minimizing leakage of the composition 1616 off the radiation-transparent substrate 1610. In the apparatus shown in FIG. 12, such a means includes three press rollers 1646, 1647, and 1648 and a belt 1649, in which two of the press rollers 1646, 1647 are disposed adjacent to the dam roller 1645 and the third press roller 1648 is disposed at a distance from the first two press rollers 1646, 1647. The belt 1649 can be radiation-transparent if it is continuous, or it may be comprised of two or more separated non-transparent portions allowing irradiation between them. The belt 1649 is configured in a loop around the three press rollers 1646, 1647, and 1648 and disposed in contact with the radiation-transparent substrate 1610. The three press rollers 1646, 1647, and 1648 are configured to apply force to the belt to maintain it in contact with the radiation-transparent substrate 1610. As the radiation-transparent substrate 1610 is conveyed, the belt 1649 traverses around the three press rollers 1646, 1647, and 1648.

In use, the apparatus 1600 operates similarly to the apparatus 1500 of FIG. 11 described above, including that as the substrate 1610 continues to be driven from an unwind roller 1652 (as well as under the dam roller 1645) to the wind roller 1618, an optional air knife (not shown) can be used to direct air towards the major surface 1611 of the substrate 1610 to assist in removing at least a portion of the composition 1616 remaining on the major surface 1611 of the substrate 1610 that was not polymerized to form a three-dimensional article 1617 and 1619 by irradiation from the irradiation source 1612. Any excess of composition 1616 can then be returned to the containment area defined by the dam roller 1645. Once a formed three-dimensional article (e.g., the three-dimensional article 1617 and the three-dimensional article 1619) reaches the wind roller 1618, the web of radiation transparent substrate 1610 is wound up. In some embodiments, the web may optionally be passed through a wash station 1635 and an oven 1637, for example, to remove solvent and/or heat the articles to thermally degrade the binder material and/or fuse the fluoropolymer particles, for example, as described in further detail below. In some embodiments, the three-dimensional articles 1617, 1619 can be removed from the radiation-transparent web before they are dried or heated in a separate location. If the three-dimensional article is a continuous web, the three-dimensional web (e.g., structured film) can be removed from the radiation-transparent substrate and dried, heated, and/or wound up in a roll in the same web process or in one or more separate web processes (not shown).

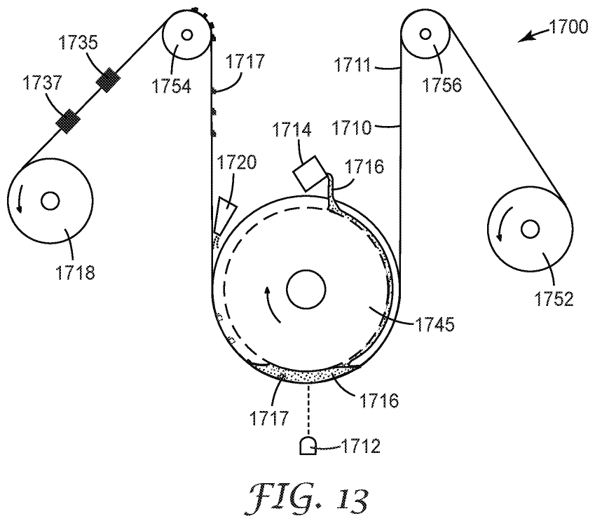

Referring to FIG. 13, another embodiment of a method according to the present disclosure is shown. FIG. 13 schematically illustrates an apparatus 1700 for use in some embodiments of the method of the present disclosure. The apparatus includes at least two rollers 1752 and 1718 configured to convey a radiation-transparent substrate 1710 and an irradiation source 1712 configured to direct radiation through the radiation-transparent substrate 1710 at predetermined dosages at predetermined locations. The apparatus 1700 further includes a means for depositing 1714 a composition 1716 onto a major surface 1711 of the radiation-transparent substrate 1710 and a means for conveying the radiation-transparent substrate 1710 or the irradiation source 1712 with respect to each other. The radiation-transparent substrate 1710 is often a consumable material obtained separately from the apparatus 1700 as opposed to being a component of the apparatus. The apparatus further includes a dam roller 1745 comprising a pair of spaced apart edges (not shown) configured to contact the radiation-transparent substrate 1710 and define a containment area between the edges to provide space for the pool of composition 1716 disposed on the radiation-transparent substrate 1710. The means for depositing 1714 comprises a container configured to dispense the composition 1716 as a thin layer onto a surface of the dam roller 1745, which travels around the dam roller 1745 and forms a pool on the major surface 1711 of the substrate 1710.

A further means may be provided to contact the dam roller 1745 with the radiation-transparent substrate 1710 to assist in minimizing leakage of the composition 1716 off the radiation-transparent substrate 1710. In the apparatus shown in FIG. 13, such a means includes two tension rollers 1754 and 1756, wherein the radiation-transparent substrate 1710 is fed over one tension roller 1756, under the dam roller 1745, and over the other tension roller 1754. This configuration allows the tension rollers 1754 and 1756 to be configured to apply force to the radiation-transparent substrate 1710 to maintain the substrate 1710 in contact with the dam roller 1745 as the radiation-transparent substrate 1710 is conveyed through the apparatus.

In use, the apparatus 1700 operates similarly to the apparatus 1500 of FIG. 11 described above, including that as the substrate 1710 continues to be driven from an unwind roller 1752 (as well as over the first tension roller 1756, under the dam roller 1745, and over the second tension roller 1754) to wind roller 1718, an air knife 1720 directs air towards the major surface 1711 of the substrate 1710 to assist in removing at least a portion of the composition 1716 remaining on the major surface 1711 of the substrate 1710 that was not polymerized to form a three-dimensional article by irradiation from the irradiation source 1712. Any excess of composition 1716 can then be returned to the containment area defined by the dam roller 1745. Once a formed three-dimensional article 1717 reaches the wind roller 1718, the web of radiation transparent substrate 1710 is wound up. In some embodiments, the web may optionally be passed through a wash station 1735 and an oven 1737, for example, to remove solvent and/or heat the articles to thermally degrade the binder material and/or fuse the fluoropolymer particles, for example, as described in further detail below. In some embodiments, the three-dimensional articles 1717 can be removed from the radiation-transparent web before they are dried or heated in a separate location. If the three-dimensional article is a continuous web, the three-dimensional web (e.g., structured film) can be removed from the radiation-transparent substrate and dried, heated, and/or wound up in a roll in the same web process or in one or more separate web processes (not shown).

Referring to FIG. 14, another embodiment of a method according to the present disclosure is shown. FIG. 14 schematically illustrates an apparatus 1800 for use in some embodiments of the method of the present disclosure. The apparatus includes at least two rollers 1852 and 1818 (at least one of which is configured to convey a radiation-transparent substrate 1810) and an irradiation source 1812 configured to direct radiation through the radiation-transparent substrate 1810 at predetermined dosages at predetermined locations. The apparatus 1800 further includes a means for depositing 1814 a composition 1816 onto a major surface 1811 of the radiation-transparent substrate 1810 and a means for conveying the radiation-transparent substrate 1810 or the irradiation source 1812 with respect to each other. The radiation-transparent substrate 1810 is often a consumable material obtained separately from the apparatus 1800 as opposed to being a component of the apparatus. The apparatus further includes a dam roller 1845 comprising a pair of spaced apart edges (not shown) configured to contact the radiation-transparent substrate 1810 and define a containment area between the edges to provide space for the pool of composition 1816 disposed on the radiation-transparent substrate 1810. The means for depositing 1814 comprises a container configured to dispense the composition 1816 as a thin layer onto a surface of the dam roller 1845, which travels around the dam roller 1845 and forms a pool on the major surface 1811 of the substrate 1810.

A further means may be provided to contact the dam roller 1845 with the radiation-transparent substrate 1810 to assist in minimizing leakage of the composition 1816 off the radiation-transparent substrate 1810. In the apparatus shown in FIG. 14, such a means includes two tension rollers 1854 and 1856, wherein the radiation-transparent substrate 1810 is fed over one tension roller 1856, under the dam roller 1845, and over the other tension roller 1854. This configuration allows the tension rollers 1854 and 1856 to be configured to apply force to the radiation-transparent substrate 1810 to maintain the substrate 1810 in contact with the dam roller 1845 as the radiation-transparent substrate 1810 is conveyed through the apparatus. In the apparatus shown in FIG. 14, the tension rollers are disposed adjacent to the dam roller 1845 such that the radiation-transparent substrate 1810 is in contact with over 50 percent of the circumference of the dam roller 1845 to further assist in minimizing leakage of the composition 1816 off the radiation-transparent substrate 1810.

In use, the apparatus 1800 operates similarly to the apparatus 1500 of FIG. 1 described above, including that as the substrate 1810 continues to be driven from an unwind roller 1852 (as well as over the first tension roller 1856, under the dam roller 1845, and over the second tension roller 1854) to the wind roller 1818 an air knife 1820 optionally directs air towards the major surface 1811 of the substrate 1810 to assist in removing at least a portion of the composition 1816 remaining on the major surface 1811 of the substrate 1810 that was not polymerized to form three-dimensional article by irradiation from the irradiation source 1812. Any excess of composition 1816 can then be returned to the containment area defined by the dam roller 1845. Once a formed three-dimensional article 1817 reaches the wind roller 1818, the web of radiation transparent substrate 1810 is wound up. Further, in some embodiments, the formed three-dimensional article 1817 is heated by one or more heaters 1832 to dry and/or heat the three-dimensional article before winding up the substrate 1810. In other embodiments, the three-dimensional articles 1817 can be removed from the radiation-transparent web before they are dried or heated in a separate location. If the three-dimensional article is a continuous web, the three-dimensional web (e.g., structured film) can be removed from the radiation-transparent substrate and further dried, heated, and/or wound up in a roll in the same web process or in one or more separate web processes (not shown).

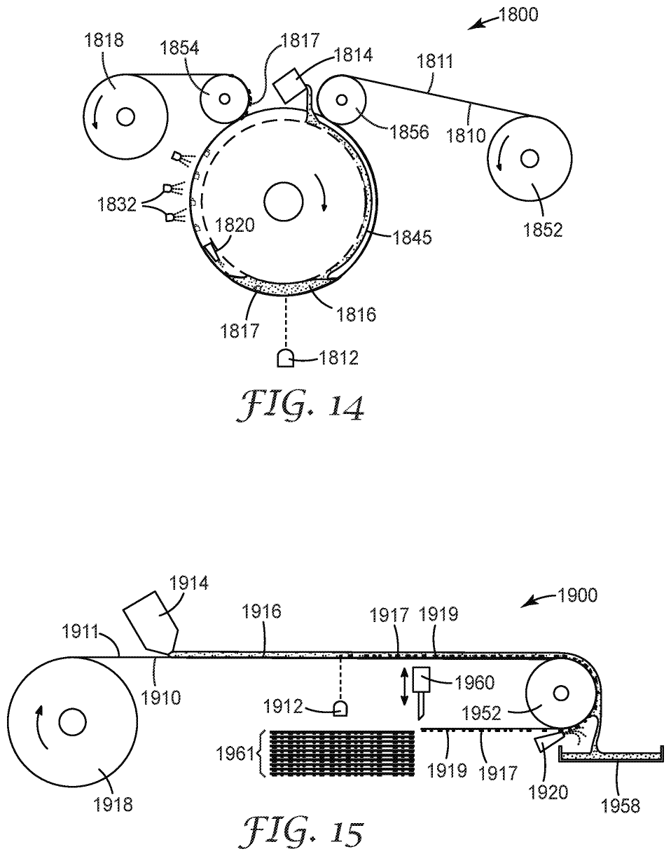

Referring to FIG. 15, another embodiment of a method according to the present disclosure is shown. FIG. 15 schematically illustrates an apparatus 1900 for use in some embodiments of the method of the present disclosure. The apparatus includes at least two rollers 1952 and 1918 (at least one of which is configured to convey a radiation-transparent substrate 1910), and an irradiation source 1912 configured to direct radiation through the radiation-transparent substrate 1910 at predetermined dosages at predetermined locations. The apparatus 1900 further includes a means for depositing 1914 a composition 1916 onto a major surface 1911 of the radiation-transparent substrate 1910 and a means for conveying (not shown) the radiation-transparent substrate 1910 or the irradiation source 1912 with respect to each other. The means for depositing 1914 comprises a die configured to dispense the composition 1916 on the major surface 1911 of the substrate 1910. In such embodiments, the composition 1916 is sufficiently viscous to remain on the major surface 1911 of the substrate 1910 without leaking off of the side edges of the substrate 1910. The radiation-transparent substrate 1910 is often a consumable material obtained separately from the apparatus 1900 as opposed to being a component of the apparatus. Optionally, an air knife 1920 configured to remove at least a portion of the non-polymerized composition 1916 from the substrate 1910 where one or more three-dimensional articles 1917 and 1919 are formed is provided with the apparatus 1900.

A further optional component of the apparatus 1900 is a blade 1960 that slices portions of the substrate 1910 on which one or more three-dimensional articles 1917, 1919 are disposed. In the embodiment shown in FIG. 15, a stack 1961 of pieces of substrate 1910 comprising one or more formed three-dimensional articles is illustrated.

In some embodiments, the apparatus shown in FIG. 15 is operated as follows: A die 1914 deposits a composition 1916 on a major surface 1911 of a radiation-transparent substrate 1910. An irradiation source 1912 directs radiation through the radiation-transparent substrate 1910 at one or more predetermined dosages at one or more predetermined locations. The composition 1916 that has been irradiated at least partially polymerizes, forming at least one three-dimensional article, such as the three-dimensional article 1919 and the three-dimensional article 1917, shown in FIG. 15. One portion of three-dimensional article 1917 has a greater thickness than another portion of the same three-dimensional article 1917. This may be achieved by irradiating one portion of the article 1917 with a greater dosage than another portion is irradiated. In contrast, three-dimensional article 1919 has a single thickness across its width due to receiving the same dosage across its width. A roller 1918 drives a web of the radiation-transparent substrate 1910 over a roller 1952 to allow gravity to begin separating the composition 1916 that was not polymerized to form a three-dimensional article (e.g., 1917 and 1919). As the substrate 1910 continues to be driven from a first roller 1918 to a second roller 1952, an air knife 1920 directs air towards the major surface 1911 of the substrate 1910 to assist in removing the at least a portion of the composition 1916 remaining on the major surface 1911 of the substrate 1910. The excess composition 1916 can be deposited in a container 1958 for recycling or reuse. Once a particular section of the substrate 1910 holding at least one formed three-dimensional article (e.g., the three-dimensional article 1917 and/or the three-dimensional article 1919) reaches the blade 1960, the blade 1960 is employed and that portion of radiation transparent substrate 1910 is sliced off (and optionally added to a stack 1961 of substrate 1910 pieces each comprising at least one formed three-dimensional article. In some embodiments, the three-dimensional articles 1917, 1919 can be removed from the radiation-transparent web before they are dried or heated in a separate location. If the three-dimensional article has a continuous backing, the three-dimensional web (e.g., structured film) can be removed from the pieces of radiation-transparent substrate in the stack 1961 and dried, heated, and/or stacked separately.

Any of the above-mentioned irradiation sources are suitable for use in each of the apparatuses of the disclosed embodiments herein. It is an advantage of these irradiation sources that they are readily configured to provide one or more predetermined dosages of irradiation at one or more predetermined locations, allowing the manufacture of three-dimensional articles having variations in size and shape, particularly in thickness normal to a substrate.

In some embodiments, a (e.g., non-transitory) machine-readable medium is employed in the method of making a three-dimensional article of the present disclosure. Data is typically stored on the machine-readable medium. The data represents a three-dimensional model of an article, which can be accessed by at least one computer processor interfacing with additive manufacturing equipment (e.g., a 3D printer, a manufacturing device, etc.). The data is used to cause the additive manufacturing equipment to create the three-dimensional article.

Data representing an article may be generated using computer modeling such as computer aided design (CAD) data. Image data representing the (e.g., polymeric) article design can be exported in STL format, or in any other suitable computer processable format, to the additive manufacturing equipment. Scanning methods to scan a three-dimensional object may also be employed to create the data representing the article. One exemplary technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer.

In some embodiments, the method of making a three-dimensional article of the present disclosure comprises retrieving, from a (e.g., non-transitory) machine-readable medium, data representing a model of a desired three-dimensional article. The method further includes executing, by one or more processors interfacing with a manufacturing device, manufacturing instructions using the data; and generating, by the manufacturing device, the three-dimensional article.

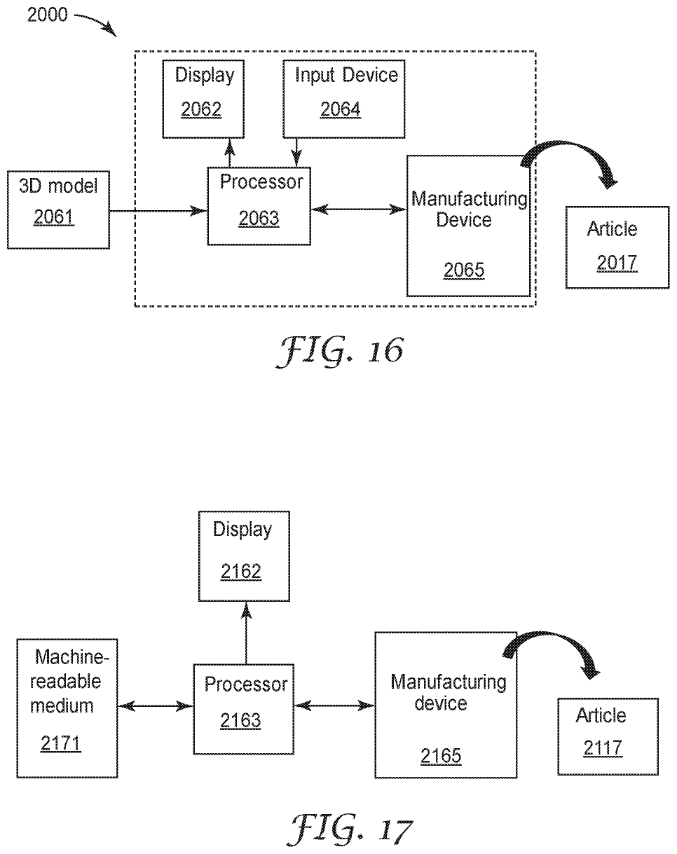

FIG. 16 illustrates an embodiment of a system 2000 for carrying out some embodiments of the method according to the present disclosure. The system 2000 comprises a display 2062 that displays a model 2061 of a three-dimensional article; and one or more processors 2063 that, in response to the 3D model 2061 selected by a user, cause a manufacturing device 2065 to create the three-dimensional article 2017. Often, an input device 2064 (e.g., keyboard and/or mouse) is employed with the display 2062 and the at least one processor 2063, particularly for the user to select the model 2061.

Referring to FIG. 17, a processor 2163 (or more than one processor) is in communication with each of a machine-readable medium 2171 (e.g., a non-transitory medium), a manufacturing device 2165, and optionally a display 2162 for viewing by a user. The manufacturing device 2165 is configured to make one or more articles 2117 based on instructions from the processor 2163 providing data representing a model of the article 2117 from the machine-readable medium 2171.

In the embodiments illustrated in FIGS. 6 to 15, the substrate is transparent to the irradiation, and irradiating is carried out by irradiating through the substrate. In some embodiments, the substrate comprises at least one of a polymer or glass (e.g., in FIGS. 6 to 9). When the radiation-transparent substrate comprises a polymeric material, examples of suitable polymeric substrates include polyethylene terephthalate, polyethylene naphthalate, polycarbonate, polyimide, cycloolefin films, poly(methyl methacrylate), various fluoropolymer films (e.g., ethylene tetrafluoroethylene (ETFE), perfluoroalkoxy alkane (PFA), or polytetrafluoroethylene (PTFE)), and combinations thereof. In some embodiments, the substrate comprises a release liner, a fluoropolymer film, or a glass comprising a release coating. The release liner can comprise, for example, polyethylene terephthalate and silicone or polypropylene and silicone. When the radiation-transparent substrate comprises glass, suitable examples of glass substrates include sodium borosilicate glass, soda-lime glass, and quartz glass. As the irradiation first reaches the composition that is in contact with the radiation-transparent substrate, the binder material polymerizes on the surface of the substrate and continues to polymerize in a direction normal to the substrate surface. In these embodiments, the binder material in contact with the substrate is polymerized. Furthermore, for any line normal to the substrate surface that passes through polymerized binder material, there is typically no non-polymerized material between the substrate surface and the polymerized material.

It can be seen in any of FIGS. 6 to 15 that the three-dimensional article made by the method of the present disclosure has a first surface in contact with the radiation-transparent substrate and a second surface opposite the first surface. The first and second surfaces define opposite sides of the three-dimensional article. It is evident from FIGS. 6 to 15 that the second surface of the three-dimensional article is not in contact with the apparatus when the first surface is in contact with the radiation-transparent substrate. The second surface is not attached, for example, to a second substrate, opposite the radiation-transparent substrate.

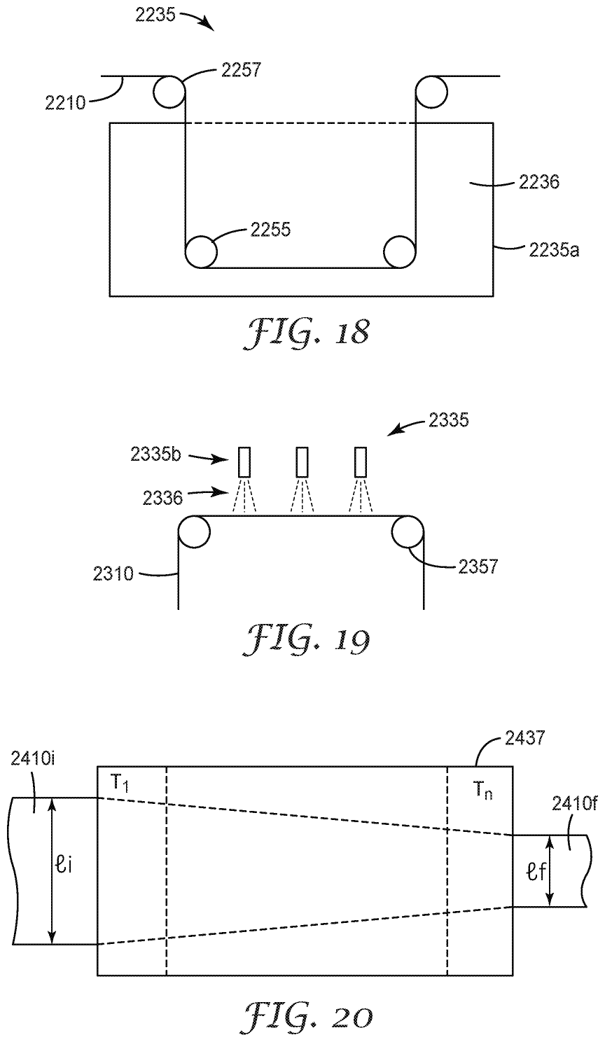

Referring now to FIGS. 18 and 19, examples of wash stations useful in connection with any of the apparatuses shown in FIGS. 10 to 15 are illustrated. FIGS. 18 and 19 illustrate wash stations 2235 and 2335, respectively, that can be useful in embodiments of the method of the present disclosure carried out as a web process. In FIG. 18, a web of substrate 2210 carrying three-dimensional articles (not shown) is passed through a tank 2235a including a solvent 2236, which may be an organic solvent or water. The tank may include an agitator (not shown) to assist in removing at least a portion of any composition remaining on the substrate 2210 that was not polymerized to form a three-dimensional article by irradiation. The substrate web is guided around rollers 2255 and 2257 as it enters and exits tank 2235a. In FIG. 19, a web of substrate 2310 carrying three-dimensional articles (not shown) is guided on rollers 2357 to a series of sprayers 23356b. Sprayers 2335b spray solvent 2336, which may be an organic solvent or water, to assist in removing at least a portion of any composition remaining on the substrate 2310 that was not polymerized to form a three-dimensional article by irradiation. Wash station 2335 can include a container (not shown) underneath the web for collection of the solvent and excess composition.

Referring now to FIG. 20, an example of an oven 2437 useful in connection with any of the apparatuses shown in FIGS. 10 to 15 are illustrated. FIG. 20 illustrates web 2410i entering oven 2437 and web 2410f exiting oven 2437. Oven 2437 may have various temperature zones T₁ to Tₙ. Web 2410i may be a structured film or other web construction having features of varying heights (not shown). When the three-dimensional article is a web construction, shrinkage generally occurs as it is passed through the oven 2437, and the initial width of the web l i is typically greater than the final width of the web lf. A series of rollers (not shown) may be useful inside the oven 2437 to assist with achieving uniform shrinkage. Pressure may be applied to web 2410i in the oven to minimize curling or distortion of the web. Also, the substrate can be chosen to match the shrinkage through the thermal cycle. In some embodiments, the substrate can be a fluoropolymer film as described above that may have similar shrinkage as the three-dimensional web article.

In the method according to the present disclosure, the first irradiation dosage and the second irradiation dosages are both non-zero dosages. When the first irradiation dosage and the second irradiation dosage are not the same, a three-dimensional article is formed having a variable thickness in an axis normal to the substrate. In some embodiments, the first irradiation dosage and the second irradiation dosage differ in at least one of time or radiation intensity. Time may be continuous or pulsed. When different times are used in the first and second irradiation dosages, it is typically the cumulative exposure times to the radiation that are different. The time of irradiation of the first dosage may be shorter or longer than the time of irradiation of the second dosage. Similarly, the radiation intensity of the first dosage may be lower or higher than the radiation intensity of the second dosage. Irradiating the first portion occurs before irradiating the second portion, at the same time as irradiating the second portion, or a combination thereof. In some embodiments, irradiating the first portion and irradiating the second portion occur simultaneously, at least for the duration of one of the first irradiation dosage or the second irradiation dosage.

In some embodiments, methods according to the present disclosure can be useful for polymerizing through the entire thickness of a composition comprising fluoropolymer particles and a binder material that is polymerizable upon exposure to radiation. In other words, the first portion of the three-dimensional article can have the same thickness as the first portion of the composition or the second portion of the three-dimensional article can have the same thickness as the second portion of the composition as long as the first portion of the three-dimensional article has a different thickness in an axis normal to the surface of the substrate than the second portion of the three-dimensional article. In some embodiments of the methods according to the present disclosure the thickness of at least one of the first portion or the second portion of the three-dimensional article is a fraction of the thickness of the composition disposed on the surface of the substrate, wherein the fraction is less than 1. In some embodiments, the ratio of the thickness of at least one of the first or second portion of the three-dimensional article to the thickness of the composition disposed on the surface of the substrate is 10:90, 15:85, 20:80, 25:75, 30:70, 40:60, or 45:55. In these embodiments, the method according to the present disclosure may be distinguished from photolithography and other additive manufacturing methods in which individual layers of precursor compositions are each cured throughout the thickness (i.e., z-direction). When the thickness of at least one of the first portion or the second portion of the three-dimensional article is a fraction of the thickness of the composition disposed on the surface of the substrate, wherein the fraction is less than 1, the second surface of the three-dimensional article, described above, is generally at least partially covered by the composition and can be completely covered by the composition.

The temperature(s) at which method according to the present disclosure are performed is not particularly limited. In some embodiments, irradiation is carried out at room temperature (e.g., 20-25° C.). In some embodiments at least one of the first irradiation dosage or the second irradiation dosage is provided at an elevated temperature, for example, above 25° C. and up to 150° C., up to 130° C., up to 110° C., up to 100° C., up to 90° C., up to 80° C., up to 70° C., up to 60° C., up to 50° C., or up to 40° C. In some embodiments, the method is performed at a temperature between 20° C. and 150° C., inclusive; between 30° C. and 150° C., inclusive; between 25° C. and 100° C., inclusive; or between 25° C. and 70° C., inclusive. The temperature employed is typically limited only by the lowest maximum temperature at which a material used in the method (e.g., a substrate, an apparatus component, etc.) remains thermally stable.

The method of the present disclosure utilizes compositions including fluoropolymer particles and a binder material that is polymerizable upon exposure to radiation.

Fluoropolymers useful for the compositions and methods disclosed herein include amorphous fluoropolymers, fluorothermoplastics, and non-melt-processable fluoroplastics. Fluoropolymers useful for practicing the present disclosure can comprise interpolymerized units derived from at least one partially fluorinated or perfluorinated ethylenically unsaturated monomer represented by formula R⁸CF═CR^{a}₂, wherein each R^{a} is independently fluoro, chloro, bromo, hydrogen, a fluoroalkyl group (e.g. perfluoroalkyl having from 1 to 8, 1 to 4, or 1 to 3 carbon atoms and optionally interrupted by one or more oxygen atoms), a fluoroalkoxy group (e.g. perfluoroalkoxy having from 1 to 8, 1 to 4, or 1 to 3 carbon atoms, optionally interrupted by one or more oxygen atoms), alkyl having up to 10 carbon atoms, alkoxy having up to 8 carbon atoms, or aryl having up to 8 carbon atoms. Examples of useful fluorinated monomers represented by formula R^{a}CF═CR^{a}₂ include vinylidene fluoride (VDF), tetrafluoroethylene (TFE), hexafluoropropylene (HFP), chlorotrifluoroethylene, 2-chloropentafluoropropene, trifluoroethylene, vinyl fluoride, dichlorodifluoroethylene, 1,1-dichlorofluoroethylene, 1-hydropentafluoropropylene, 2-hydropentafluoropropylene, tetrafluoropropylene, perfluoroalkyl perfluorovinyl ethers, perfluoroalkyl perfluoroallyl ethers, and mixtures thereof.

In some embodiments, the fluoropolymer useful for practicing the present disclosure includes units from one or more monomers independently represented by formula CF₂═CFORf, wherein Rf is perfluoroalkyl having from 1 to 8, 1 to 4, or 1 to 3 carbon atoms, optionally interrupted by one or more —O— groups. Perfluoroalkoxyalkyl vinyl ethers suitable for making a fluoropolymer include those represented by formula CF₂═CF(OCₙF₂ₙ)_{z}ORf₂, in which each n is independently from 1 to 6, z is 1 or 2, and Rf₂ is a linear or branched perfluoroalkyl group having from 1 to 8 carbon atoms and optionally interrupted by one or more —O— groups. In some embodiments, n is from 1 to 4, or from 1 to 3, or from 2 to 3, or from 2 to 4. In some embodiments, n is 1 or 3. In some embodiments, n is 3. CₙF₂ₙ may be linear or branched. In some embodiments. CₙF₂ₙ can be written as (CF₂)ₙ, which refers to a linear perfluoroalkylene group. In some embodiments, CₙF₂ₙ is —CF₂—CF₂—CF₂—. In some embodiments, CₙF₂ₙ is branched, for example, —CF₂—CF(CF₃)—. In some embodiments, (OCₙF₂ₙ)₂ is represented by —O—(CF₂)₁₋₄—[O(CF₂)₁₋₄]₀₋₁. In some embodiments, Rf₂ is a linear or branched perfluoroalkyl group having from 1 to 8 (or 1 to 6) carbon atoms that is optionally interrupted by up to 4, 3, or 2 —O— groups. In some embodiments, Rf₂ is a perfluoroalkyl group having from 1 to 4 carbon atoms optionally interrupted by one —O— group. Suitable monomers represented by formula CF₂═CFORf and CF₂═CF(OCₙF₂ₙ)₂ORf₂ include perfluoromethyl vinyl ether, perfluoroethyl vinyl ether, perfluoropropyl vinyl ether, CF₂CFOCF₂OCF₃, CF₂═CFOCF₂OCF₂CF₃, CF₂ ═CFOCF₂CF₂OCF₃, CF₂═CFOCF₂CF₂CF₂OCF₃, CF₂ ═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF(OCF₂)₄OCF₃, CF₂═CFOCF₂CF₂OCF₂OCF₂OCF₃, CF₂═CFOCF₂CF₂OCF₂CF₂CF₃, CF₂ ═CFOCF₂CF₂OCF₂CF₂OCF₂CF₂CF₃, CF₂═CFOCF₂CF(CF₃)—O—C₃F₇ (PPVE-2), CF₂ ═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkyl vinyl ethers can be prepared according to the methods described in U.S. Pat. Nos. 6,255,536 (Worm et al.) and 6,294,627 (Worm et al).

Perfluoroalkyl alkene ethers and perfluoroalkoxyalkyl alkene ethers may also be useful for making a fluoropolymer for the composition, method, and structured film according to the present disclosure. In addition, the fluoropolymers may include interpolymerized units of fluoro (alkene ether) monomers, including those described in U.S. Pat. No. 5,891,965 (Worm et al.) and 6,255,535 (Schulz et al.). Such monomers include those represented by formula CF₂═CF(CF₂)ₘ—O—R_{f}, wherein m is an integer from 1 to 4, and wherein R_{f} is a linear or branched perfluoroalkylene group that may include oxygen atoms thereby forming additional ether linkages, and wherein R_{f} contains from 1 to 20, in some embodiments from 1 to 10, carbon atoms in the backbone, and wherein R_{f} also may contain additional terminal unsaturation sites. In some embodiments, m is 1. Examples of suitable fluoro (alkene ether) monomers include perfluoroalkoxyalkyl allyl ethers such as CF₂═CFCF₂—O—CF₃, CF₂═CFCF₂—O—CF₂—O—CF₃, CF₂═CFCF₂—O—CF₂CF₂—O—CF₃, CF₂═CFCF₂—O—CF₂CF₂—O—CF₂—O—CF₂CF₃, CF₂═CFCF₂—O—CF₂CF₂—O—CF₂CF₂CF₂—O—CF₃, CF₂═CFCF₂—O—CF₂CF₂—O—CF₂CF₂—O—CF₂—O—CF₃, CF₂═CFCF₂CF₂—O—CF₂CF₂CF₃. Suitable perfluoroalkoxyalkyl allyl ethers include those represented by formula CF₂═CFCF₂(OCₙF₂ₙ)₂ORf₂, in which n, z, and Rf₂ are as defined above in any of the embodiments of perfluoroalkoxyalkyl vinyl ethers. Examples of suitable perfluoroalkoxyalkyl allyl ethers include CF₂═CFCF₂OCF₂CF₂OCF₃, CF₂═CFCF₂OCF₂CF₂CF₂OCF₃, CF₂ ═CFCF₃OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₃CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂ ═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan).

Fluoropolymers useful for practicing the present disclosure may also comprise interpolymerized units derived from the interpolymerization of at least one monomer R^{a}CF═CR^{a}₂ with at least one non-fluorinated, copolymerizable comonomer represented by formula R^{b}₂C═CR^{b}₂, wherein each R^{b} is independently hydrogen, chloro, alkyl having from 1 to 8, 1 to 4, or 1 to 3 carbon atoms, a cyclic saturated alkyl group having from 1 to 10, 1 to 8, or 1 to 4 carbon atoms, or an aryl group of from 1 to 8 carbon atoms, or represented by formula CH₂═CHR¹⁰, wherein R¹⁰ is a hydrogen or alkyl. In some embodiments, R¹⁰ is alkyl having up to 10 carbon atoms or from one to six carbon atoms. Examples of useful monomers represented by these formulas include ethylene and propylene.

Perfluoro-1,3-dioxoles may also be useful to prepare a fluoropolymer useful for practicing the present disclosure. Perfluoro-1,3-dioxole monomers and their copolymers are described in U.S. Pat. No. 4,558,141 (Squire).

In some embodiments, the fluoropolymer useful for practicing the present disclosure is amorphous. Amorphous fluoropolymers typically do not exhibit a melting point and exhibit little or no crystallinity at room temperature. In some embodiments, useful amorphous fluoropolymers have glass transition temperatures below room temperature or up to 280° C. In some embodiments, suitable amorphous fluoropolymers can have glass transition temperatures in a range from −60° C. up to 280° C., −60° C. up to 250° C., from −60° C. to 150° C., from −40° C. to 150° C., from −40° C. to 100° C., from −40° C. to 20° C., from 80° C. to 280° C., from 80° C. to 250° C., or from 100° C. to 250° C.

In some embodiments, useful amorphous fluoropolymers include copolymers of VDF with at least one terminally unsaturated fluoromonoolefin represented by formula R^{a}CF═CR^{a}₂ containing at least one fluorine atom on each double-bonded carbon atom. Examples of comonomers that can be useful with VDF include HFP, chlorotrifluoroethylene, 1-hydropentafluoropropylene, and 2-hydropentafluoropropylene. Other examples of amorphous fluoropolymers useful for practicing the present disclosure include copolymers of VDF, TFE and HFP or 1- or 2-hydropentafluoropropylene and copolymers of TFE, propylene, and, optionally. VDF. Such fluoropolymers are described in U.S. Pat. Nos. 3,051,677 (Rexford) and 3,318,854 (Honn, et al.) for example. In some embodiments, the amorphous fluoropolymer is a copolymer of HFP. VDF and TFE. Such fluoropolymers are described in U.S. Pat. No. 2,968,649 (Pailthorp et al.), for example.

Amorphous fluoropolymers including interpolymerized units of VDF and HFP typically have from 30 to 90 percent by weight VDF units and 70 to 10 percent by weight HFP units. Amorphous fluoropolymers including interpolymerized units of TFE and propylene typically have from about 50 to 80 percent by weight TFE units and from 50 to 20 percent by weight propylene units. Amorphous fluoropolymers including interpolymerized units of TFE, VDF, and propylene typically have from about 45 to 80 percent by weight TFE units, 5 to 40 percent by weight VDF units, and from 10 to 25 percent by weight propylene units. Those skilled in the art are capable of selecting specific interpolymerized units at appropriate amounts to form an amorphous fluoropolymer. In some embodiments, polymerized units derived from non-fluorinated olefin monomers are present in the amorphous fluoropolymer at up to 25 mole percent of the fluoropolymer, in some embodiments up to 10 mole percent or up to 3 mole percent.

In some embodiments, polymerized units derived from at least one of perfluoroalkyl vinyl ether or perfluoroalkoxyalkyl vinyl ether monomers are present in the amorphous fluoropolymer at up to 50 mole percent of the fluoropolymer, in some embodiments up to 30 mole percent or up to 10 mole percent.

In some embodiments, amorphous fluoropolymers useful for practicing the present disclosure include a TFE/propylene copolymer, a TFE/propylene/VDF copolymer, a VDF/HFP copolymer, a TFE/VDF/HFP copolymer, a TFE/perfluoromethyl vinyl ether (PMVE) copolymer, a TFE/CF₂—CFOC₃F₇ copolymer, a TFE/CF₂═CFOCF₃/CF₂═CFOC₃F₇ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/VDF/PMVE/ethylene copolymer, or a TFE/VDF/CF₂═CFO(CF₂)₃OCF₃ copolymer.

Amorphous fluoropolymers useful for practicing the present disclosure also include those having glass transition temperatures in a range from 80° C. to 280° C., from 80° C. to 250° C., or from 100° C. to 250° C. Examples of such fluoropolymers include copolymers of perfluorinated 1,3-dioxoles optionally substituted by perfluoroC₁₋₄alkyl or perfluoroC₁₋₄alkoxy with at least one compound of formula R^{a}CF═CR^{a}₂, in some embodiments, TFE. Examples of perfluorinated 1,3-dioxoles suitable for making amorphous fluoropolymers include 2,2-bis(trifluoromethyl)-4,5-difluoro-1,3-dioxole, 2,2-bis(trifluoromethyl)-4-fluoro-5-trifluoromethoxy 1,3-dioxole, 2,4,5-trifluoro-2-trifluoromethyl-1,3-dioxole, 2,2,4,5-tetra(fluoro-1,3-dioxole, and 2,4,5-trifluoro-2-pentafluoroethyl-1,3-dioxole. Some of these amorphous polymers are commercially available, for example, from The Chemours Company, Wilmington, Del., under the trade designation “TEFLON AF” and from Solvay, Brussels, Belgium, under the trade designation “HYFLON AD”. Other useful amorphous fluoropolymers include poly(perfluoro-4-vinyloxy-1-butene), which is commercially available under the trade designation “CYTOP” from Asahi Glass, Tokyo, Japan, and poly(perfluoro-4-vinyloxy-3-methyl-1-butene). Several perfluoro-2-methylene-1,3-dioxolanes can be homopolymerized or copolymerized with each other and/or with compounds represented by formula R^{a}CF═CR^{a}₂ to provide useful amorphous fluoropolymers. Suitable perfluoro-2-methylene-1,3-dioxolane may be unsubstituted, substituted by at least one of perfluoroC₁₋₄alkyl or perfluoroC₁₋₄alkoxyC₁₋₄alkyl, or fused to a 5- or 6-membered perfluorinated ring, optionally containing an oxygen atom. One example of a useful substituted perfluoro-2-methylene-1,3-dioxolanes is poly(perfluoro-2-methylene-4-methyl-1,3-dioxolane. Further examples and details about these amorphous fluoropolymers can be found in “Amorphous Fluoropolymers” by Okamot, et al., Chapter 16 in Handbook of Fluoropolymer Science and Technology, First Edition, Ed. Smith. D. W., Iacono, S. T., and Iyer, S., 2014, pp. 377 to 391.

In some embodiments, amorphous fluoropolymers have a glass transition temperature of up to 50° C. and have a Mooney viscosity in a range from 1 to 100 (ML 1+10) at 121° C. Mooney viscosity is determined using ASTM D1646-06 Part A by a MV 2000 instrument (available from Alpha Technologies, Ohio, USA) using a large rotor (ML 1+10) at 121° C. Mooney viscosities specified above are in Mooney units.

In some embodiments, components useful for preparing an amorphous fluoropolymer further include a fluorinated bisolefin compound represented by the following formula:

CY₂═CX—(CF₂)ₐ—(O—CF₂—CF(Z))_{b}—O—(CF₂)_{c}—(O—CF(Z)—CF₂)_{d}—(O)ₑ—(CF(A))_{f}—CX═CY₂,

wherein a is an integer selected from 0, 1, and 2; b is an integer selected from 0, 1, and 2; c is an integer selected from 0, 1, 2, 3, 4, 5, 6, 7, and 8; d is an integer selected from 0, 1, and 2; e is 0 or 1; f is an integer selected from 0, 1, 2, 3, 4, 5, and 6; Z is independently selected from F and CF₃; A is F or a perfluorinated alkyl group; X is independently H or F; and Y is independently selected from H, F, and CF₃. In some embodiments, the highly fluorinated bisolefin compound is perfluorinated, meaning that X and Y are independently selected from F and CF₃. Examples of useful fluorinated bisolefin compounds include: CF₂═CF—O—(CF₂)₂—O—CF═CF₂, CF₂═CF—O—(CF₂)₃—O—CF═CF₂, CF₂═CF—O—(CF₂)₄—O—CF₂═CF₂, CF₂═CF—O—(CF₂)₅—O—CF═CF₂, CF₂═CF—O—(CF₂)₆—O—CF═CF₂, CF₂═CF—CF₂—O—(CF₂)₂—O—CF═CF₂, CF₂═CF—CF₂—O—(CF₂)₃—O—CF═CF₂, CF₂═CF—CF₂—O—(CF₂)₄—O—CF═CF₂, CF₂═CF—CF₂—O—(CF₂)₅—O—CF═CF₂, CF₂═CF—CF₂—O—(CF₂)₆—O—CF═CF₂, CF₂═CF—CF₂—O—(CF₂)₂—O—CF₂—CF═CF₂, CF₂═CF—CF₂—O—(CF₂)₃—O—CF₂CF═CF₂, CF₂═CF—CF₂—O—(CF₂)₄—O—CF₂—CF═CF₂, CF₂═CF—CF₂—O—(CF₂)₅—O—CF₂—CF═CF₂, CF₂═CF—CF₂—O—(CF₂)₆—O—CF₂—CF═CF₂, CF₂═CF—O—CF₂CF₂—CH═CH₂, CF₂═CF—(OCF(CF₃)CF₂)—O—CF₂CF₂—CH═CH₂, CF₂═CF—(OCF(CF₃)CF₂)₂—O—CF₂CF₂—CH═CH₂, CF₂═CFCF₂—O—CF₂CF₂—CH═CH₂, CF₂═CF CF₂—(OCF₂CF(CF₃))—O—CF₂CF₂—CH═CH₂, CF₂═CFCF₂—(OCF₂CF(CF₃)₂—O—CF₂CF₂—CH═CH₂. CF₂═CF—CF₂—CH═CH₂, CF₂═CF—O—(CF₂)_{c}—O—CF₂—CF₂—CH═CH₂ wherein c is an integer selected from 2 to 6, CF₂═CFCF₂—O—(CF₂)_{c}—O—CF₂—CF₂—CH═CH₂ wherein c is an integer selected from 2 to 6, CF₂═CF—(OCF₂CF(CF₃))_{b}—O—CF(CF₃)—CH═CH₂ wherein b is 0, 1, or 2, CF₂═CF—CF₂—(OCF₂CF(CF₃))_{b}—O—CF(CF₃)—CH═CH₂ wherein b is 0, 1, or 2, CH₂═CH—(CF₂)ₙ—O—CH═CH₂ wherein n is an integer from 1-10, and CF₂═CF—(CF₂)ₐ—(O—CF₂CF(CF₃))_{b}—O—(CF₂)_{c}—(OCF(CF₃))CF₂)_{f}—O—CF═CF₂ wherein a is 0 or 1, b is 0, 1, or 2, c is 1, 2, 3, 4, 5, or 6, and f is 0, 1, or 2. In some embodiments, the fluorinated bisolefin compound is CF₂═CF—O—(CF₂)ₙ—O—CF═CF₂ where n is an integer from 2-6; CF₂═CF—(CF₂)ₐ—O—(CF₂)ₙ—O—(CF₂)_{b}—CF═CF₂ where n is an integer from 2-6 and a and b are 0 or 1; or a perfluorinated compound comprising a perfluorinated vinyl ether and a perfluorinated allyl ether. Useful amounts of the fluorinated bisolefin include 0.01 mol % to 1 mol % of the fluorinated bisolefin compound based on total moles of monomer incorporated. In some embodiments, at least 0.02, 0.05, or even 0.1 mol % of the fluorinated bisolefin compound is used and at most 0.5, 0.75, or even 0.9 mol % of a compound of the fluorinated bisolefin compound is used based on the total moles of monomer incorporated into the amorphous polymer.

In some embodiments, the amorphous fluoropolymer useful in the composition and method of the present disclosure includes polymerized units comprising a cure site. In these embodiments, cure site monomers may be useful during the polymerization to make the amorphous fluoropolymer. Such cure site monomers include those monomers capable of free radical polymerization. The cure site monomer can be perfluorinated to ensure adequate thermal stability of the resulting elastomer. Examples of useful cure sites include a Br cure site, an I cure site, a nitrile cure site, a carbon-carbon double bond, and combinations thereof. Any of these cure sites can be cured using peroxides as described below. However, in some cases in which multiple, different cure sites are present a dual cure system or a multi cure system may be useful. Other suitable cure systems that may be useful include bisphenol curing systems or triazine curing systems.

In some embodiments, the cure site monomer comprises an iodine capable of participating in a peroxide cure reaction, where, for example, the iodine atom capable of participating in the peroxide cure reaction is located at a terminal position of the backbone chain. One example of a useful fluorinated iodine containing cure site monomer is represented by the following formula:

CY₂═CX—(CF₂)_{g}—(O—CF₂CF(CF₃))ₕ—O—(CF₃)ᵢ—(O)ⱼ—(CF₂)ₖ—CF(I)—X (IV)

wherein X and Y are independently selected from H, F, and CF₃; g is 0 or 1; h is an integer selected from 0, 2, and 3; i is an integer selected from 0, 1, 2, 3, 4, and 5; j is 0 or 1; and k is an integer selected from 0, 1, 2, 3, 4, 5, and 6. In one in embodiment, the fluorinated iodine containing cure site monomer is perfluorinated. Examples of suitable compounds of Formula (IV) include: CF₂═CFOC₄F₈I (MV4I), CF₂═CFOC₂F₄I, CF₂═CFOCF₂CF(CF₃)OC₂F₄I, CF₂═CF—(OCF₂CF(CF₃))₂—O—C₂F₄I, CF₂═CF—O—CF₂CFI—CF₃, CF₂═CF—O—CF₂CF(CF₃)—O—CF₂CFI—CF₃, CF₂═CF—O—((C₂)₂—O—C₂F₄I, CF₂═CF—O—(CF₂)₃—O—C₂F₄I, CF₂═CF—O—(CF₂)₄—O—C₂F₄I, CF₂═CF—O—(CF₂)₅—O—C₂F₄I, CF₂═CF—O—(CF₂)₆—O—C₂F₄I, CF₂═CF—CF₂—O—CF₂—O—C₂F₄I, CF₂═CF—CF₂—O—(CF₂)₂—O—C₂F₄I, CF₂═CF—CF₂—O—(CF₂)₃—O—C₂F₄I, CF₂═CF—CF₂—O—(CF₂)₄—O—C₂F₄I, CF₂═CF—CF₂—O—(CF₂)₅—O—C₂F₄I, CF₂═CF—CF₂—O—(CF₂)₆—O—C₂F₄I, CF₂═CF—CF₂—O—C₄F₈I, CF₂═CF—CF₂—O—C₂F₄I, CF₂═CF—CF₂—O—CF₂CF(CF₃)—O—C₂F₄I, CF₂═CF—CF₂—(OCF₂CF(CF₃))₂—O—C₂F₄I, CF₂═CF—CF₂—O—CF₂CFI—CF₃, CF₂═CF—CF₂—O—CF₂CF(CF₃)—O—CF₂CFI—CF₃, and combinations thereof. In some embodiments, the cure site monomer comprises at least one of CF₂ ═CFOC₄F₈I; CF₂═CFCF₂OC₄F₈I; CF₂═CFOC₂F₄I; CF₂═CFCF₂OC₂F₄I; CF₂═CF—O—(CF₂)ₙ—O—CF₂—CF₂I, or CF₂═CFCF₂—O—(CF₂)ₙ—O—CF₂—CF₂I wherein n is an integer selected from 2, 3, 4, or 6. Examples of other useful cure site monomers include bromo- or iodo-(per)fluoroalkyl-(per)fluorovinylethers having the formula ZRf—O—CX═CX₂, wherein each X may be the same or different and represents H or F, Z is Br or I, Rf is a C₁-C₁₂ (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂, wherein Z represents Br or I. Still other examples of useful cure site monomers include bromo- or iodo (per)fluoroolefins such as those having the formula Z′—(Rf′)ᵣ—CX═CX₂, wherein each X independently represents H or F, Z′ is Br or I, Rf is a C₁-C₁₂ perfluoroalkylene, optionally containing chlorine atoms and r is 0 or 1. Suitable examples include bromo- or iodo-trifluoroethene, 4-bromo-perfluorobutene-1,4-iodo-perfluorobutene-1, or bromo- or iodo-fluoroolefins such as 1-iodo-2,2-difluororoethene, 1-bromo-2,2-difluoroethene, 4-iodo-3,3,4,4,-tetrafluorobutene-1 and 4-bromo-3,3,4-tetrafluorobutene-1. Non-fluorinated bromo and iodo-olefins such as vinyl bromide, vinyl iodide, 4-bromo-1-butene and 4-iodo-1-butene may also be useful as cure site monomers.

Useful amounts of the compound of Formula (IV) and the other cure site monomers described above include 0.01 mol % to 1 mol %, based on total moles of monomer incorporated may be used. In some embodiments, at least 0.02, 0.05, or even 0.1 mol % of a cure site monomer is used and at most 0.5, 0.75, or even 0.9 mol % of a cure site monomer is used based on the total moles of monomer incorporated into the amorphous fluoropolymer.

In some embodiments of the amorphous fluoropolymer useful in the composition and method of the present disclosure includes a nitrile cure site. Nitrile cure sites can be introduced into the polymer by using nitrile containing monomers during the polymerization. Examples of suitable nitrile containing monomers include those represented by formulas CF₂═CF—CF₂—O—Rf—CN; CF₂═CFO(CF₂)ᵣCN; CF₂═CFO[CF₂CF(CF₃)O]ₚ(CF₂)ᵥOCF(CF₃)CN; and CF₂═CF[OCF₂CF(CF₃)]ₖO(CF₂)ᵤCN, wherein, r represents an integer of 2 to 12; p represents an integer of 0 to 4; k represents 1 or 2; v represents an integer of 0 to 6; u represents an integer of 1 to 6, Rf is a perfluoroalkylene or a bivalent perfluoroether group. Specific examples of nitrile containing fluorinated monomers include perfluoro (8-cyano-5-methyl-3,6-dioxa-1-octene), CF₂═CFO(CF₂)₅CN, and CF₂═CFO(CF₂)₃OCF(CF₃)CN. Typically these cure-site monomers, if used, are used in amounts of at least 0.01, 0.02, 0.05, or 0.1 mol % and at most 0.5, 0.75, 0.9, or 1 mol % based on the total moles of monomer incorporated into the amorphous fluoropolymer.

If the amorphous fluoropolymer is perhalogenated, in some embodiments perfluorinated, typically at least 50 mole percent (mol %) of its interpolymerized units are derived from TFE and/or CTFE, optionally including HFP. The balance of the interpolymerized units of the amorphous fluoropolymer (e.g., 10 to 50 mol %) is made up of one or more perfluoroalkyl vinyl ethers and/or perfluoroalkoxyalkyl vinyl ethers and/or perfluoroallyl ethers and/or perfluoroalkoxyalkyl ethers, and, in some embodiments, a cure site monomer. If the fluoropolymer is not perfluorinated, it typically contains from about 5 mol % to about 90 mol % of its interpolymerized units derived from TFE, CTFE, and/or HFP; from about 5 mol % to about 90 mol % of its interpolymerized units derived from VDF, ethylene, and/or propylene; up to about 40 mol % of its interpolymerized units derived from a vinyl ether; and from about 0.1 mol % to about 5 mol %, in some embodiments from about 0.3 mol % to about 2 mol %, of a cure site monomer.

In some embodiments, the fluoropolymer useful for practicing the present disclosure is a semi-crystalline fluorothermoplastic. Useful semi-crystalline fluoropolymers are melt processable with melt flow indexes, for example, in a range from 1 gram per ten minutes to 10,000 grams per ten minutes (20 kg/372° C.), in a range from 0.5 grams per ten minutes to 1,000 grams per ten minutes (5 kg/372° C.), or in a range from 0.01 grams per ten minutes to 10,000 grams per ten minutes (5 kg/297° C.). In some embodiments, suitable semi-crystalline fluoropolymers can have melting points in a range from 50° C. up to 325° C., from 100° C. to 325° C., from 150° C. to 325° C., from 100° C. to 300° C., or from 80° C. to 290° C.

Examples of suitable semi-crystalline fluorinated thermoplastic polymers include fluoroplastics derived solely from VDF and HFP. These fluoroplastics typically have interpolymerized units derived from 99 to 67 weight percent of VDF and from 1 to 33 weight percent HFP, more in some embodiments, from 90 to 67 weight percent VDF and from 10 to 33 weight percent HFP. Another example of a useful fluoroplastic is a fluoroplastic having interpolymerized units derived solely from (i) TFE and (ii) more than 5 weight percent of one or more ethylenically unsaturated copolymerizable fluorinated monomers other than TFE. Copolymers of TFE and HFP with or without other perfluorinated comonomers are known in the art as FEP's (fluorinated ethylene propylene). In some embodiments, these fluoroplastics are derived from copolymerizing 30 to 70 wt. % TFE, 10 to 30 wt. %, HFP, and 5 to 50 wt. % of a third ethylenically unsaturated fluorinated comonomer other than TFE and HFP. For example, such a fluoropolymer may be derived from copolymerization of a monomer charge of TFE (e.g., in an amount of 45 to 65 wt. %), HFP (e.g., in an amount of 10 to 30 wt. %), and VDF (e.g., in an amount of 15 to 35 wt. %). Copolymers of TFE, HFP and vinylidenefluoride (VDF) are known in the art as THV. Another example of a useful fluoroplastic is a fluoroplastic derived from copolymerization of a monomer charge of TFE (e.g., from 45 to 70 wt %), HFP (e.g., from 10 to 20 wt %), and an alpha olefin hydrocarbon ethylenically unsaturated comonomer having from 1 to 3 carbon atoms, such as ethylene or propylene (e.g., from 10 to 20 wt. %). Another example of a useful fluoroplastic is a fluoroplastic derived from TFE and an alpha olefin hydrocarbon ethylenically unsaturated comonomer. Examples of polymers of this subclass include a copolymer of TFE and propylene and a copolymer of TFE and ethylene (known as ETFE). Such copolymers are typically derived by copolymerizing from 50 to 95 wt. %, in some embodiments, from 85 to 90 wt. %, of TFE with from 50 to 15 wt. %, in some embodiments, from 15 to 10 wt. %, of the comonomer. Still other examples of useful fluoroplastics include polyvinylidene fluoride (PVDF) and a VdF/TFE/CTFE including 50 to 99 mol % VdF units, 30 to 0 mol % TFE units, and 20 to 1 mol % CTFE units.

In some embodiments, the semi-crystalline fluorinated thermoplastic is a copolymer of a fluorinated olefin and at least one of a fluorinated vinyl ether or fluorinated allyl ether. In some of these embodiments, the fluorinated olefin is TFE. Copolymers of TFE and perfluorinated alkyl or allyl ethers are known in the art as PFA's (perfluorinated alkoxy polymers). In these embodiments, the fluorinated vinyl ether or fluorinated allyl ether units are present in the copolymer in an amount in a range from 0.01 mol % to 15 mol %, in some embodiments, 0.01 mol % to 10 mol %, and in some embodiments, 0.05 mol % to 5 mol %. The fluorinated vinyl ether or fluorinated allyl ether may be any of those described above. In some embodiments, the fluorinated vinyl ether comprises at least one of perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, or CF₃—(CF₂)₂—O—CF(CF₃)—CF₂—O—CF(CF₃)—CF₂—O—CF═CF₂.

Semi-crystalline fluorinated thermoplastics described above in any of their embodiments may be prepared with or without cure site monomers as described above in any of their embodiments. The fluorothermoplasts may be linear or branched, for example in case they contain branched comonomers like HFP. Longer branches may be created by using branching modifiers in the polymerization as described, for example, in U.S. Pat. No. 8,969,500 (Hintzer et al.). The branching modifiers can include any of the bisolefins described above in connection with amorphous fluoropolymers.

In some embodiments, the fluoropolymer useful for practicing the present disclosure has a very high melt viscosity and/or low melt flow index (MFI) such that it is termed in the art as “non-melt processable”. Non-melt processable fluoropolymers include homopolymers of TFE or copolymers of TFE with other copolymerizable perfluorinated monomers, wherein the amount of comonomers is limited to up to about 1 percent by weight. Such TFE homo- and copolymers are referred to in the art as PTFE. PTFE has such a high melt viscosity that it cannot be processed by conventional melt processing techniques such as extrusion, injection molding, or blow molding. PTFE articles typically are formed by ram extrusion, or by press-sintering PTFE particles into billets that are then machined into the desired shape. These are subtractive methods where material is removed to shape articles.

In some embodiments, the fluoropolymer is a copolymer of TFE and one or more perfluorinated comonomers such as HFP, CTFE, a perfluoroalkyl vinyl ether, a perfluoro alkyl allyl ether, or combinations thereof. In some embodiments, the fluoropolymer contains TFE and at least one perfluoroalkyl vinyl ether comonomer and no other comonomer. In some embodiments, the fluoropolymer contains TFE and at least one perfluoroalkyl allyl ether comonomer and no other comonomer. In some embodiments, the fluoropolymer contains a combination of perfluoroalkyl vinyl ether and perfluoroalkyl allyl ether comonomers and no other comonomers. In any of these embodiments, the amount of the perfluorinated comonomers may be up to 2% by weight based on the total weight of the fluoropolymer, in some embodiments, up to 1% by weight or up to 0.1% by weight. For example, the amount of the comonomers can be from about 0.1 to 2, from 0.1 to 1 percent by weight, or from 0.3 to 1 percent by weight, all based on the total weight of the fluoropolymer.

In some embodiments, the non-melt-processable fluoropolymer useful for practicing the present disclosure has a melt flow index (MFI) of 1.0 g/10 min or less at 372° C. using a 5 kg load (MFI 372/5 of less than 1.0 g/10 min), in some embodiments, a melt flow index (372/5) of 0.1 g/10 minutes or less. In some embodiments, the non-melt-processable fluoropolymer useful for practicing the present disclosure has a melting point of at least 300° C., in some embodiments, at least 315° C., and typically within the range of 327+/−10° C. In some embodiments, the non-melt-processable fluoropolymer has a melting point of at least 317° C., at least 319° C., or at least 321° C. The melting point of not melt-processable fluoropolymers differs when the material is molten for the first time and after subsequent melting. After the material has been molten once, the meting point in subsequent melting remains constant. The melting point as referred to herein is the melting point of previously molten material (i.e., the material was brought to the melting point, cooled below its melting point, and then melted again).

The non-melt-processable fluoropolymers may have a standard specific gravity (SSG) of between 2.13 and 2.23 g/cm³ as measured according to ASTM 4895. The SSG is a measure for the molecular weight of the polymer. The higher the SSG, the lower the molecular weight. In some embodiments, fluoropolymers useful for practicing the present disclosure are ultra-high molecular weight PTFEs, having an SSG of less than 2.17 g/cm³, in some embodiments, an SSG of between 2.14 and 2.16. Such PTFE polymers and their preparation is described, for example, in U.S. Pat. Appl. Pub. No. 2013/0040142 (Frey et al.).

The non-melt-processable fluoropolymers may have different polymer architectures, for example, core-shell polymers, random polymers, or polymers prepared under continuous and constant polymerization conditions.

Conveniently, the fluoropolymers are dispersed in the composition comprising fluoropolymer particles and a binder material that is polymerizable. The fluorinated polymers can have a small particle size to facilitate a homogenous dispersion. Typically, the particle size corresponds to particles sizes obtained by preparing fluoropolymers in an aqueous emulsion polymerization as known in the art and described below. The fluoropolymers typically have a particle sizes of less than 2,000 nanometers (nm). In some embodiments, the fluoropolymer particles have an average particle size (D₅₀) of from 50 to 500 nm, or from 70 to 350 nm. Using fluoropolymers of any of these particle sizes may facilitate the creation of dense fluoropolymer articles, for example, shaped fluoropolymers with a high density and/or low void content. However, in application where lower density or porous article are desired, larger particle size or different heat treatment or sintering schemes can be applied. The porosity of the resulting shaped article may be controlled this way.

Fluoropolymers useful for practicing the present disclosure, including amorphous and semi-crystalline fluoropolymers described in any of the above embodiments, are commercially available and/or can be prepared by a sequence of steps, which can include polymerization, coagulation, washing, and drying. In some embodiments, an aqueous emulsion polymerization can be carried out continuously under steady-state conditions. For example, an aqueous emulsion of monomers (e.g., including any of those described above), water, emulsifiers, buffers and catalysts can be fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The fluoropolymer can be recovered from the latex by coagulation, if desired.

The polymerization is generally conducted in the presence of a free radical initiator system, such as ammonium persulfate, potassium permanganate, A IBN, or bis(perfluoroacyl) peroxides. The polymerization reaction may further include other components such as chain transfer agents and complexing agents. The polymerization is generally carried out at a temperature in a range from 10° C. and 100° C. or in a range from 30° C. and 80° C. The polymerization pressure is usually in the range of 0.3 MPa to 30 MPa. and in some embodiments in the range of 2 MPa and 20 MPa.

When conducting emulsion polymerization, perfluorinated or partially fluorinated emulsifiers may be useful. Generally these fluorinated emulsifiers are present in a range from about 0.02% to about 3% by weight with respect to the polymer. An example of a useful fluorinated emulsifier is represented by formula:

Y—Rf—Z-M

wherein Y represents hydrogen, Cl or F; Rf represents a linear or branched perfluorinated alkylene having 4 to 10 carbon atoms; Z represents COO⁻ or SO₃⁻ and M represents an alkali metal ion or an ammonium ion. Such fluorinated surfactants include fluorinated alkanoic acid and fluorinated alkanoic sulphonic acids and salts thereof, such as ammonium salts of perfluorooctanoic acid and perfluorooctane sulphonic acid. Also contemplated for use in the preparation of the polymers described herein are fluorinated emulsifiers represented by formula:

[Rf—O-L-COO—]ᵢXⁱ⁺

wherein L represents a linear partially or fully fluorinated alkylene group or an aliphatic hydrocarbon group. Rf represents a linear partially or fully fluorinated aliphatic group or a linear partially or fully fluorinated group interrupted with one or more oxygen atoms, Xⁱ⁺ represents a cation having the valence i and i is 1, 2 and 3. In one embodiment, the emulsifier is selected from CF₃—O—(CF₂)₃—O—CHF—CF₂—C(O)OH and salts thereof. Specific examples are described in US 2007/0015937. Other examples of useful emulsifiers include: CF₃CF₂OCF₂CF₂OCF₂COOH, CHF₂(CF₂)₅COOH, CF₃(CF₂)₆COOH, CF₃O(CF₂)₃OCF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂(OCF(CF₃)CF₂)OCF(CF₃)COOH, CF₃(CF₂)₂(OCF₂CF₂)₄OCF(CF₃)COOH, CF₃CF₂O(CF₂CF₂O)₃CF₂COOH, and their salts. Also contemplated for use in the preparation of the fluorinated polymers described herein are fluorinated polyether surfactants, such as described in U.S. Pat. No. 6,429,258.

Polymer particles produced with a fluorinated emulsifier typically have an average diameter, as determined by dynamic light scattering techniques, in range of about 10 nanometers (nm) to about 300 nm, and in some embodiments in range of about 50 nm to about 200 nm. If desired, the emulsifiers can be removed or recycled from the fluoropolymer latex as described in U.S. Pat. Nos. 5,442,097 to Obermeier et al., 6,613,941 to Felix et al., 6,794,550 to Hintzer et al., 6,706,193 to Burkard et al, and 7,018,541 to Hintzer et al. In some embodiments, the polymerization process may be conducted with no emulsifier (e.g., no fluorinated emulsifier). Polymer particles produced without an emulsifier typically have an average diameter, as determined by dynamic light scattering techniques, in a range of about 40 nm to about 500 nm, typically in range of about 100 nm and about 400 nm, and suspension polymerization will typically produce particles sizes of at least 500 micrometers and up to several millimeters. In some embodiments, the particle size of the fluoropolymer particles in the composition is 500 μm or less, 50 μm and less, or 5 μm and less. In any event, practical manufacturing limits may dictate that such particles have a size of 0.1 μm or larger, 0.5 μm or larger, or even 1 μm or larger. In other words, the present description includes the ranges beginning at 0, 1, 0.5, or 1 μm and up to 5, 50, or 500 μm (as determined by z-average particle size). Fluoropolymer particles may be milled to such particle sizes.

In some embodiments, a water soluble initiator can be useful to start the polymerization process. Salts of peroxy sulfuric acid, such as ammonium persulfate, are typically applied either alone or sometimes in the presence of a reducing agent, such as bisulfites or sulfinates (e.g., fluorinated sulfinates disclosed in U.S. Pat. Nos. 5,285,002 and 5,378,782 both to Grootaert) or the sodium salt of hydroxy methane sulfinic acid (sold under the trade designation “RONGALIT”, BASF Chemical Company, New Jersey, USA). Most of these initiators and emulsifiers have an optimum pH-range where they show most efficiency. For this reason, buffers are sometimes useful. Buffers include phosphate, acetate or carbonate buffers or any other acid or base, such as ammonia or alkali metal hydroxides. The concentration range for the initiators and buffers can vary from 0.01% to 5% by weight based on the aqueous polymerization medium.

Aqueous polymerization using the initiators described above will typically provide fluoropolymers with polar end groups; (see, e.g., Logothetis, Prog. Polym. Sci., Vol. 14, pp. 257-258 (1989)). If desired, such as for improved processing or increased chemical stability, the presence of strong polar end groups such as SO₂⁽⁻⁾ and COO⁽⁻⁾ in fluoropolymers can be reduced through known post treatments (e.g., decarboxylation, post-fluorination). Chain transfer agents of any kind can significantly reduce the number of ionic or polar end groups. The strong polar end groups can be reduced by these methods to any desired level. In some embodiments, the number of polar functional end groups (e.g., —COF, —SO₂F, —SO₃M, —COO-alkyl, —COOM, or —O—SO₃M, wherein alkyl is C₁-C₃ alkyl and M is hydrogen or a metal or ammonium cation), is reduced to less than or equal to 500, 400, 300, 200, or 100 per 10⁶ carbon atoms. The number of polar end groups can be determined by known infrared spectroscopy techniques. In some embodiments, it may be useful to select initiators and polymerization conditions to achieve at least 1000 polar functional end groups (e.g., —COF. —SO₂F, —SO₃M, —COO-alkyl, —COOM, or —O—SO₃M, wherein alkyl is C₁-C₃ alkyl and M is hydrogen or a metal or ammonium cation) per 10⁶ carbon atoms, at least 4000 per 10⁶ carbon atoms, or at least 5000 per 10⁶ carbon atoms. When a fluoropolymer has at least 1000, 2000, 3000, 4000, or 5000 polar functional end groups per 10⁶ carbon atoms, the fluoropolymer may have increased interaction with, for example, any inorganic filler that may be present.

Chain transfer agents and any long-chain branching modifiers described above can be fed into the reactor by batch charge or continuously feeding. Because feed amount of chain transfer agent and/or long-chain branching modifier is relatively small compared to the monomer feeds, continuous feeding of small amounts of chain transfer agent and/or long-chain branching modifier into the reactor can be achieved by blending the long-chain branding modifier or chain transfer agent in one or more monomers.

Adjusting, for example, the concentration and activity of the initiator, the concentration of each of the reactive monomers, the temperature, the concentration of the chain transfer agent, and the solvent using techniques known in the art can control the molecular weight of the fluoropolymer. Molecular weight of a fluoropolymer relates to the melt flow index. Fluoropolymers useful for practicing the present disclose may have melt flow indexes in a range from 0.01 grams per ten minutes to 10,000 grams per ten minutes (20 kg/372° C.), in a range from 0.5 grams per ten minutes to 1,000 grams per ten minutes (5 kg/372° C.), or in a range from 0.01 grams per ten minutes to 10,000 grams per ten minutes (5 kg/297° C.).

Various grades of fluoropolymer dispersions as described herein are commercially available, for example from Dyneon GmbH, Burgkirchen Germany and from other fluoropolymer producers.

In some embodiments, the amount of fluoropolymer in the composition useful for practicing the present disclosure is in a range from about 25 percent to about 70 percent, from about 30 percent to about 60 percent, from about 25 percent to about 60 percent, from about 40 percent to about 55 percent, from about 30 percent to about 50 percent, or from about 31 percent to about 45 percent, with each of these percentages by weight, based on the total weight of the composition. In some embodiments, the amount of fluoropolymer particles in the composition is at least about 30 percent or at least about 50 percent by weight, based on the total weight of the composition. The optimum concentration may depend on the type and amounts of the other components in the composition, for example, the binder material, filler, or any of the others described below. In some embodiments, the fluoropolymer particles are dispersed in an aqueous medium and the composition comprises an aqueous dispersion of fluoropolymer particles. It is generally useful to maximize the fluoropolymer content of the compositions, but the concentration of fluoropolymer may be limited by stability of the dispersion due to coagulation or precipitation of fluoropolymers or the viscosity of the dispersion.

In compositions useful for practicing the present disclosure, the fluoropolymers may be dispersed in the binder material or in a dispersing medium (e.g., water, organic solvent, or a combination thereof). In some embodiments, the composition comprising fluoropolymer particles and a binder material that is polymerizable is an aqueous composition. In a convenient way to prepare homogeneous compositions, an aqueous dispersion of the fluoropolymers is provided to which the other components are added. Compositions may be created from dispersions that have been upconcentrated, for example, by removing water content through evaporation or thermal treatment. Another way of making compositions useful for practicing the present disclosure includes suspending or dispersing coagulated fluoropolymers in suitable solvents and combining them with the binders or other optional components.

Compositions useful for practicing the present disclosure may comprise at least one stabilizing surfactant. The surfactant may be fluorinated or non-fluorinated, and typically, it is nonionic or amphoteric. Examples of suitable surfactants include those that provide sufficient shear stability to the fluoropolymer dispersion but degrade or evaporate at the heat process in the work-up procedure. Useful amounts of surfactants may vary and depend on the binder material and ratio of binder material to fluoropolymer, foaming properties of surfactants, compatibility of the surfactants with the other ingredients, and surface-activity of the surfactants. Low-foaming surfactants may be desirable. If present, the amount of stabilizing surfactant may be in a range from 0.5% to 12% by weight, based on the total weight of the composition.

Examples of suitable stabilizing surfactants include ethoxylated alcohols, amine oxide surfactants, and ethoxylated amine surfactants as will be described in greater detail below. Examples of ethoxylated alcohol surfactants can be selected from the group of alkylarylpolyethoxy alcohols, polyoxyalkylene alkyl ether surfactants, and alkoxylated acetylenic diols, in some embodiments, ethoxylated acetylenic diols, and mixtures of such surfactants. Further examples of suitable stabilizing surfactants include sugar-based surfactants, such as glycoside surfactants and polysorbates such as described, for example, in WO2011/014715 A2 (Zipplies et al).

In some embodiments, the surfactant is a nonfluorinated, nonionic surfactant or mixture of surfactants represented by formula R¹O—X—R³, wherein R¹ represents a linear, branched, or cyclic aliphatic or aromatic hydrocarbon group that may contain one or more catenary oxygen atoms and having at least 8 carbon atoms, in some embodiments, 8 to 18 carbon atoms. In some embodiments, R¹ is (R′)(R″)C— wherein R′ and R″ are the same or different, linear, branched or cyclic alkyl groups. R⁵ represents hydrogen or a C₁-C₃ alkyl group. X represents a plurality of ethoxy units that can also contain one or more propoxy unit. For example, X may represent —[CH₂CH₂O]ₙ—[R²O]ₘ—R² represents an alkylene having 3 carbon atoms, n has a value of 0 to 40, m has a value of 0 to 40 and the sum of n+m is at least 2 and the units indexed by n and m may be arranged at random. Also mixtures of the above surfactants may be used. Commercially available nonionic surfactants or mixtures of nonionic surfactants include those available from Clariant GmbH under the trade designation GENAPOL such as GENAPOL X-080 and GENAPOL PF 40. Further suitable nonionic surfactants that are commercially available include those of the trade designation Tergitol TMN 6, Tergitol TMN 100× and Tergitol TMN 10 from Dow Chemical Company.

In some embodiments, the surfactant is an amine oxide surfactant represented by formula (R¹)(R²)(R³)N→O), wherein R¹ is radical of the formula R⁴—(C═O)ₐ—X—(C═O)_{b}(CH₃)ₙ—, wherein R⁴ is a saturated or unsaturated, branched or unbranched, cyclic or acyclic, alkyl, hydroxyalkyl, ether or hydroxyether radical having 1 to 20 carbon atoms, X is an O, NH or NR⁵, a and b are 0 or 1 with the proviso that a+b=1, and n is 2-6; R⁵ is selected from saturated or unsaturated, branched or unbranched, cyclic or acyclic, alkyl, hydroxyalkyl, ether or hydroxyether radical having 1 to 10 carbon atoms optionally substituted with halogen or an N-oxylamnino group; wherein R² and R³ are independently selected from saturated or unsaturated, branched or unbranched, cyclic or acyclic, alkyl, hydroxyalkyl, ether or hydroxyether radical having 1 to 10 carbon atoms optionally substituted with halogen, wherein R² and R³ may be joined by a chemical bond to form a ring. If R², R³ R⁴ and R⁵ have halogen substitutions, the halogen substitutions are typically limited such that no more than about 70% or not more than about 50% of the atoms attached to carbon atoms of the radical are halogen atoms. In some embodiments, R², R³, R⁴ and R⁵ are not halogen substituted. If R⁵ is substituted with N-oxylamino, groups bonded to the nitrogen atom typically have 1 to 10 carbon atoms. In some embodiments. R³ is represented by formula R⁴—(C═O)ₐ—X—(C═O)_{b}—(CH₂)ₙ—, wherein R⁴ represents alkyl having 1 to 20 carbon atoms. X is NH, a and b are 0 or 1 with the proviso that a+b=1, and n is 2-1. In some of these embodiments. R⁴ represents alkyl having 5-20 carbon atoms, and n is 3. In some embodiments, R² and R³ in the formula (R¹)(R²)(R³)N→O are independently selected from saturated or unsaturated, branched or unbranched, cyclic or acyclic, alkyl or hydroxyalkyl radical having 1 to 4 carbon, atoms. In some embodiments, R² and R³ in the formula above are each independently selected from alkyl or hydroxyalkyl radicals having 1 to 2 carbon atoms.

Specific examples of surfactants represented by formula (R¹)(R²)(R³)N→O include cocoamidopropyl dimethyl amine oxide, 2-ethylhexylamidopropyl dimethyl amine oxide, and octylamidopropyl dimethyl amine oxide. Amine oxide surfactants are commercially available, for example, under the trade designation GENAMINOX from Clariant. In some embodiments, the amine oxide surfactant is that described, for example, in U.S. Pat. No. 8,097,673 (Jones).

In some embodiments, the surfactant is an ethoxylated amine surfactant. In some embodiments, the ethoxylated amine surfactant is represented by formula R¹R²—N—(CH₂CH₂O)ₙH or

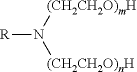

wherein each R¹, R² and R is independently a branched, linear, or cyclic alkyl, alkyloxy, or polyoxy alkyl group having at least 4, 6, 8, 10, or more and up to 30 or up to 20 carbon atoms. In some embodiments, R¹, R² and R independently has in a range from 6 to 18 carbon atoms. In some embodiments, at least one of R¹, R², or R is alkyl-substituted (e.g., with a methyl or ethyl group) in the 1-position (that is, the position adjacent to the N-atom) or di-alkyl-substituted in the 1-position. The total number of carbon atoms in the molecule may be up to 50, 40, or up to 20.

In both formulas of ethoxylated amine surfactants above, n and m represent an integer and being independently from each other 1, 2, 3, 4, 5, 6, 7, 8, 9, 10, 11, 12, 13 or 14 or 1 to 10, 1 to 6 or 1 to 4. In some embodiments, the sum of n and m is less than 30, less than 25, or less than 20. The sum of n and m may also be 2, 3, 4, 5, 8, 10, 12, 20 or 25.

In some embodiments, at least one of R¹, R² and R is represented by formula R′—(OCH₂—CR″H)ₓ—, wherein R′ represents hydrogen; a branched, linear, or cyclic alkyl; or aryl group. R″ represents hydrogen or an alkyl group including, for example, a methyl, ethyl, propyl, isopropyl, or butyl group, and x represents an integer of from 1, 2, 3, or 1 to 10, 1 to 6 or 1 to 4. In some embodiments, R′ is a methyl, ethyl, propyl or isopropyl group. In some embodiments, x is an integer from 1 to 10, R″ is H or CH₃, and R′ is selected from the group consisting of H or straight or branched alkyls (e.g., methyl, ethyl, propyl, or isopropyl).

Examples of readily available ethoxylated amines include those marketed under the tradename TRITON RW-Series by Dow Chemical Company, Midland, Mich., USA, such as for example TRITON RW-20, RW-50, RW-70, RW-100, RW-150, or under the trade designation GENAMIN from Clariant, Basel, Switzerland. Examples of useful ethoxylated amine surfactants are also described, for example, in U.S. Pat. No. 4,605,773 (Maloney et al.).

Compositions useful for practicing the present disclosure can include mixtures of different fluoropolymer particles, including mixtures of any of the fluoropolymers described above in any of their embodiments. In some embodiments, the composition comprises mixtures of different non-melt-processable fluoropolymers, for example polymers of different molecular weight. In some embodiments, the composition comprises a mixture of one or more non melt-processable fluoropolymer as described above with one or more PTFE micropowders. PTFE micropowders have the same molecular composition and similar melting points as PTFE's as described above but have a much lower molecular weight and melt viscosity. They have an MFI (372/5) of greater than 0.1 g/10 mins. PTFE micropowders are commercially available and are typically prepared by radiation degradation of high molecular weight PTFE followed by milling. Micropowders are also commercially available, for example from Dyneon GmbH, Burgkirchen Germany or other fluoropolymer producers.

In some embodiments, the composition useful for practicing the present disclosure comprises a blend of at least one non-melt processable fluoropolymer and at least one melt-processable fluorothermoplastic. The weight ratio of fluorothermoplastic to non-melt-processable fluoropolymers may be from 1:1 to 1:1000, or from 1:2 to 1:100. The presence of melt processable fluoropolymers in blends with non-melt processable fluoropolymers may lead to a more rapid filling of voids created by the removal of the binder material. This may be advantageous as it may lead to more dense articles after or during a thermal removal of the binder material from the article. In some of these embodiments, the fluorothermoplastic in the blend is a PFA, including any of those described above in any of their embodiments. The PFA may have a melting point between 280° C. and 315° C., for example, between 280° C. and 300° C.

Blends of fluoropolymers may be conveniently prepared by providing the polymers in the form of aqueous dispersions and then blending the dispersions. The resulting dispersion may be upconcentrated to remove water if necessary by thermal evaporation, ultrafiltration or other methods known in the art. The other ingredients of the composition may be added to the dispersion containing the fluoropolymer blends to provide the composition useful for practicing the present disclosure.

Compositions useful for practicing the present disclosure include fluoropolymer particles and a binder material that is polymerizable upon exposure to radiation. The polymerizable binder material is typically matched to the source of the radiation. For example, if the energy source is UV light, the polymerizable binder has reactive groups that are activated by irradiation with UV-light to start the polymerization. Upon polymerization the polymerizable binder forms a network with the dispersed fluoropolymer particles resulting in a solidified or gelled composition with the fluoropolymer particles contained in the polymerized binder network. This composition already has the three-dimensional shape of the final article but may contain liquid, for example water, and is referred to as “green body”. The polymerized binder can be selected such that it thermally degrades at temperatures below the melting temperature of the fluoropolymer, and, in some embodiments, it can be combusted under such conditions. The polymerized binder material can be removed thermally during a work up procedure, desirably without the article becoming dimensionally unstable. The polymerizable binder material desirably polymerizes quickly upon exposure to the first irradiation dosage and the second irradiation dosage. Suitable polymerizable binder materials include monomers, oligomers, polymers, or combinations thereof with polymerizable groups, which in some embodiments are end groups.

The amount of binder material is generally high enough such that it can solidify in the areas where the structure is to be created, in which the three-dimensional article has the desired dimensions. The binder material should be capable of polymerizing to form a solid or gel of sufficient strength to retain dimensional stability throughout the creation of the created object. In some applications, it can be advantageous to minimize the weight ratio of polymerizable binder material to fluoropolymer particles in the composition. For example, when the stability of the fluoropolymer dispersion is considered, the amount of binder material should not be so high that it leads to premature coagulation of the fluoropolymer dispersion or solution. Minimizing the weight ratio of polymerizable binder material to fluoropolymer particles also tends to reduce the amount of decomposition products of organic material that are burned out before or during sintering of the fluoropolymer particles. The amount of polymerized binder is generally low enough with respect to the fluoropolymer content to minimize or avoid shrinking of the three-dimensional article during the thermal work up process. The amount of binder may also depend on the speed at which the fluoropolymer particles sinter. If sintering proceeds quickly, the combustion gases from the binder material get trapped inside the article, which can lead to a reduced density or to surface defects. In this case oxidation catalysts may be used or the amount of binder may be reduced. The formation of voids in the finished articles created during the removal of the polymerized binder material may be minimized or even avoided by selecting an appropriate amount of polymerizable binder material.

Generally, suitable amounts of polymerizable binder material are from 1% to 50% by weight, from 2% to 25% by weight, or from 10% to 20% by weight, based on the total weight of the composition disclosed herein. Useful weight ratios of fluoropolymer to polymerizable binder material depend on the type and nature of the binder material but may include 5:1 to 1:2, in some embodiments, from 4:1 to 1:1.

In some embodiments, the polymerizable binder material is dissolved or dispersed in the composition useful for practicing the present disclosure. In some embodiments, the polymerizable binder material is liquid. As described above, the composition may comprise water, organic solvent, or a combination thereof. Dispersants may be useful for dispersing the polymerizable binder material in the composition. Any organic solvents or dispersants that may be present in the composition are generally inert and do not polymerize or react with the binder or polymerization initiator.

A variety of different binder materials are useful for practicing the present disclosure. In some embodiments, the binder material comprises at least one of a carbon-carbon double bond, a carbon-carbon triple bond, an epoxide, a silane, or reactive components that can polymerize to form polyurethanes or polyesters (e.g., hydroxyl groups, ester groups, and isocyanate groups). In some embodiments, the binder material comprises at least one of a polymerizable carbon-carbon double bond or a polymerizable carbon-carbon triple bond. Suitable polymerizable binder materials include compounds with polymerizable groups comprising one or more carbon-carbon double bonds, in some embodiments, as end groups. Examples include end groups comprising at least one of vinyl groups (e.g., H₂C═CX— groups), alpha, beta-unsaturated ketones (e.g., H₂C═C(X)—C(═O)—), allyl groups (e.g., H₂C═CX²—CX³X⁴—), vinyl ether groups (e.g., H₂C═CX—O—), vinyl ester groups (e.g., H₂C═C(X)—OC(O)—), allyl ether groups e.g., (H₂C═CX²—CX³X⁴—O—), and acrylate groups (e.g., H₂C═CX—CO₂—), and combinations thereof. In these formulas, X², X³, and X⁴ each independently represents H, methyl, halogen (i.e., F, Cl, Br, I), or nitrile, and X represents H or CH₃. In some embodiments, X², X³, and X⁴ each independently represents H or methyl. In some embodiments, X², X³, and X⁴ are each H. In some embodiments, one of X³ or X⁴ is methyl and one is H.

Examples of suitable polymerizable binder materials include at least one of a mono-acrylate (i.e., a H₂C═CH—CO₂— group) or mono-methacrylate (e.g., a H₂C═C(CH₃)—CO₂— group). Other suitable polymerizable binder materials includes poly-acrylates or poly-methacrylates, that is, compounds having more than one end and/or side groups comprising an acrylate or methacrylate group (e.g., monoacrylates, diacrylates, triacrylates, combinations thereof, and their methacrylic equivalents). Suitable acrylate and methacrylate functional compounds, which may be mono-functional or poly-functional, include monomeric, oligomeric, and polymeric acrylates and methacrylates. Oligomeric acrylates and methacrylates may have from more than one and up to 25 repeating monomeric units. Polymeric acrylates and methacrylates may have more than 25 repeating units. In some embodiments, the polymerizable binder material has a molecular weight of from 100 g/mole to 5,000 g/mole or comprises polymerizable monomers or oligomers having a molecular weight from 100 g/mole to 5,000 g/mole. Molecular weights in this range may provide a composition of a desirable viscosity. Also polymerizable binder material with molecular weights in this range may be more soluble in an aqueous dispersion than higher molecular weight material. For oligomers and polymers, the molecular weight disclosed herein is a number average molecular weight.

Examples of mono-functional acrylates and methacrylate monomers useful as polymerizable binders or components thereof include alkyl (meth)acrylates that have an alkyl group with a linear, branched, or cyclic structure. Examples of suitable alkyl (meth)acrylates include methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate.

Further examples of polymerizable binder materials or components that have other functional and include acrylic acid, methacrylic acid, beta-carboxyethyl acrylate, mono-2-(methacryloxyethyl)succinate, and mono-(methacryloxypolyethyleneglycol) succinate. Hydroxyl-containing monomers useful as binder materials or for preparing binder materials include hydroxyethyl acrylate, hydroxyethyl methacrylate, hydroxypropyl acrylate, hydroxypropyl methacrylate, hydroxyl butyl acrylate, and hydroxybutyl methacrylate. Acryloxy or methacryloxy mono-functional polyethylene oxide and polypropylene oxide may also be useful as hydroxyl-containing monomers. Other examples of useful acrylates and methacrylates include those having one or more than one acrylate or methacrylate group linked to an alkyl or alkylene chain that may be interrupted by one or more oxygen atoms.

Examples of monomers with two acrylate or methacrylate groups useful as polymerizable binders or components thereof include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Examples of monomers with three or four acrylate groups or methacrylate groups useful as polymerizable binders or components thereof include trimethylolpropane triacrylate (e.g., commercially available under the trade designation “TMPTA-N” from Cytec Industries, Inc. (Smyrna, Ga., USA) and under the trade designation “SR-351” from Sartomer), pentaerythritol triacrylate (e.g., commercially available under the trade designation “SR-444” from Sartomer), ethoxylated (3) trimethylolpropane triacrylate (e.g., commercially available under the trade designation “SR-454” from Sartomer), ethoxylated (4) pentaerythritol tetraacrylate (e.g., commercially available under the trade designation “SR-494” from Sartomer), tris(2-hydroxyethylisocyanurate) triacrylate (e.g., commercially available under the trade designation “SR-368” from Sartomer), a mixture of pentaerythritol triacrylate and pentaerythritol tetraacrylate (e.g., commercially available from Cytec Industries, Inc., under the trade designation “PETIA” with an approximately 1:1 ratio of tetraacrylate to triacrylate and under the trade designation “PETA-K” with an approximately 3:1 ratio of tetraacrylate to triacrylate), pentaerythritol tetraacrylate (e.g., commercially available under the trade designation “SR-295” from Sartomer), and di-trimethylolpropane tetraacrylate (e.g., commercially available under the trade designation “SR-355” from Sartomer).

Examples of monomers with five or six acrylate groups or methacrylate groups useful as polymerizable binders or components thereof include dipentaerythritol pentaacrylate (e.g., commercially available under the trade designation “SR-399” from Sartomer) and a hexa-functional urethane acrylate (e.g., commercially available under the trade designation “CN975” from Sartomer).

Examples of repeating units of oligomeric and polymeric acrylates and methacylates include ethoxy (i.e., —CH₂CH₂—O—) units and propoxy (i.e., —C₃H₆O—) units as well as acrylate units and/or methacrylate units and combinations thereof. Acrylates and methacrylates comprising at least one ethoxy unit are often referred to as “ethoxylated”. Examples include polyethylene glycols having one, two, or three acrylic or methacrylic end groups. Specific examples include ethoxylated trimethylol propane triacrylate, polyethylene glycol dimethacrylate, polyethylene glycol diacrylate, ethoxylated bisphenyl A dimethacrylate, ethoxylated bisphenyl A dimethacrylate, which are commercially available, for example, from Sartomer Americas, Exton, Pa., under the trade designations “SR415”, “SR252”, “SR344”, “SR9036A”, and “SR9038”, respectively. In some embodiments, the binder material comprises a polyethylene glycol di- or triacrlyate or a combination of polylethlyene glycol di- and triacrylates.

Useful polymerizable binder materials also include polymerizable silanes. Examples of polymerizable silanes include methacryloxyalkyltrialkoxysilanes and acryloxyalkyltrialkoxysilanes (e.g., 3-methacryloxypropyltrimethoxysilane, 3-acryloxypropytrimethoxysilane, and 3-(methacryloxy)propyltriethoxysilane); methacryloxyalkyldialkoxysilanes and acryloxyalkyldialkoxylsilanes (e.g., 3-(methacryloxy)propylmethyldimethoxysilane and 3-(acryloxypropyl)methyidimethoxysilane); methacryloxyatlkyldialkyalkoxysilanes or acyrloxyalkyldialkylalkoxysilanes (e.g., 3-(methacryloxy)propyldimethylethoxysilane); mercaptoalkyltrialkoxylsilanes (e.g., 3-mercaptopropyltrimethoxysilane); arylrialkoxysilanes (e.g., styrylethyltrimethoxysilane); vinylsilanes (e.g., vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, vinyltrimethoxysilane, and vinyltris(2-methoxyethoxy)silane).

The polymerizable binder material include mixtures of any two or more of the polymerizable binder materials in any of their embodiments. The polymerizable binder material or combination of binder materials may be liquid or soluble in a solvent or dispersing medium (e.g., water) included in the composition disclosed herein. Further, the composition of the polymerizable binder material can be selected for compatibility with the other components of the composition. The composition of the polymerizable binder material can be selected to adjust the strength, flexibility, and uniformity of the polymerized material and/or to adjust the thermal decomposition characteristics of the polymerized material. For example bi- or polyfunctional polymerizable binder materials may be included that generate a crosslinked network. A crosslinked network may provide greater green body gel strength to be realized at a lower energy dose. The amount of the monomer with a plurality of the polymerizable groups versus monomer having one polymerizable group can be used to adjust the flexibility and the strength of the green body and may affect the green body resolution and final article resolution.

The polymerizable binder material can be matched to the source of radiation, such that exposure of the composition to at least one of the first or second irradiation dosage allows polymerization to proceed at appropriate speed in the part of the composition that has been exposed. Alternatively or additionally, the composition may contain a photoinitiator that is reactive to the radiation, and the reacted photoinitiator then activates the reactive groups in the polymerizable binder material to initiate the polymerization. Examples of useful photoinitiators include the following classes: a) a two-component system where a radical is generated through abstraction of a hydrogen atom from a donor compound; and b) a one component system where two radicals are generated by cleavage. Examples of photoinitiators according to type (a) typically contain a moiety selected from benzophenone, xanthone or quinone in combination with an aliphatic amine. Examples of photoinitiators according to type (b) typically contain a moiety selected form benzoin ether, acetophenone, benzoyl oxime or acyl phosphine. When such photoinitiators are used, the radiation includes light that may be within or outside the visible spectrum.

Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); l-hydroxycyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Examples of commercially available photoinitiators that absorb UV light to generate radicals include 1-hydroxycyclohexyl benzophenone (available, for example, under the trade designation “IRGACURE 184” from BASF, Florham Park, N.J.), 4-(2-hydroxyethoxy)phenyl(2-hydroxy-2-propyl) ketone (available, for example, under the trade designation “IRGACURE 2529” from BASF), 2-hydroxy-2-methylpropiophenone (available, for example, under the trade designation “DAROCURE D111” from BASF and bis(2,4,6-trimethylbenzoyl)-phenylposphineoxide (available, for example, under the trade designation “IRGACURE 819” from BASF). The photoinitiator may be included in the composition at any useful level. In some embodiments, the amount of photoinitiator is at least 0.01 wt. %, at least 0.1 wt. %, or at least 0.5 wt. %, based on the total weight of the composition. In some embodiments, the amount of photoinitiator is up to 0.5 wt. %, up to 1.5 wt. % or up to 3 wt. %, based on the total weight of the composition. The amount of the photoinitiator may be in a range from 0.01 wt. % to 3 wt. % or from 0.5 wt. % to 1.5 wt. %, based on the total weight of the composition.

Compositions useful for practicing the present disclosure may also contain one or more free-radical inhibitors, to help keeping the polymerization reaction localized to the areas that have been exposed to at least the first and second irradiation dosages. Free-radical inhibitors can slow down the polymerization reaction or terminate it by acting, for example, as radical scavengers. Inhibitors for polymerization with irradiation through light, including UV light are known in the art as “photoinhibitors” and include commercially available materials such as 2,6-di-tert-butyl-4-methylphenol, available from Sigma-Aldrich. St Louis, Mo. USA. The amount of inhibitor can depend, for example, on the selected polymerizable binder material, the photoinitiator, and the energy source used. Useful amounts of inhibitors can include from 0.9 to 0.001 times the amount of polymerization initiator (by weight).

Compositions useful for practicing the present disclosure may further comprise at least one of a filler, pigment, or dye. Examples of suitable fillers include silicon carbide, boron nitride, molybdenum sulfide, aluminum oxides, carbon particles, such as graphite or carbon black, carbon fibers, and carbon nanotubes. The filler content can be adjusted as desired and in some embodiments is at least 0.01% and up to 10%, up to 30%, or up to 50% by weight, based on the total weight of the composition, depending on the fluoropolymer and binder materials used. The fillers are typically in particulate form and selected to have sufficiently small particle size to allow for a homogeneous dispersion in the composition. In some embodiments, the filler particles advantageously have a particle size of less than 500 μm, in some embodiments, less than 50 μm or less than 5 μm. Pigments and dyes can be selected to be heat-stable at the temperatures applied in the thermal work up procedures.

Ingredients that increase the irradiation energy from the radiation source may also be included in the composition useful for practicing the present disclosure. For example, when the actinic radiation comprises UV light, UV enhancers (“optical brighteners”) may be included in the composition. Optical brighteners include chemical compounds that absorb light in the ultraviolet and violet region (usually 340 nm to 370 nm) and re-emit light in the blue region (typically 420 nm to 470 nm) by fluorescence. An example of a useful optical brightener is 2,5-thiophenediylbis(5-tert-butyl-1,3-benzoxazole), commercially available under the trade designation “BENETEX OB-MI” from Mayzo, Inc., Suwanee, Ga. Optical brighteners may help to control the polymerization to localized areas.

An example of the effect of using an optical brightener is shown in a comparison of FIGS. 2 and 3. In FIG. 2, right hand side of the film lost the hexagon pattern definition and formed a circular pattern instead with increased exposure to irradiation. For the film used in FIG. 3, an optical brightener was used to increase the resolution, and first and second irradiation dosages resulted in more well defined features.

In some embodiments, the composition useful for practicing the present disclosure includes at least one oxidation catalyst. Oxidation catalysts may also be useful in the composition disclosed herein to accelerate the combustion of the binder material during the thermal work up procedure. The presence of the oxidation catalysis may help to create a smoother surface and to avoid the formation of surface defects. It is believed that when the combustion of the binder material is not completed when the fluoropolymer particles at the surface fuse during a sintering step, trapped combustion gases may lead to formation of microbubbles or micro cracks on the surface of the sintered article. The oxidation catalyst may accelerate the combustion such that the combustion gases have evaporated before the fluoropolymer particles on the surface fuse. Oxidation catalysts are described for example in U.S. Pat. No. 4,120,608 and include cerium oxides or other metal oxides. Cerium oxide is commercially available from Nyacol Nano Technologies Inc.

In some embodiments, the fluoropolymer in compositions and methods disclosed herein is crosslinkable, forming a thermoset in the three-dimensional article. A fluoropolymer described above including at least one cure site monomer is crosslinkable, and the three-dimensional object formed from such a fluoropolymer can be a fluoroelastomer. A commonly used cure system is based on a peroxide cure reaction using appropriate curing compounds having or creating peroxides. It is generally believed that the bromine or iodine atoms are abstracted in the free radical peroxide cure reaction, thereby causing the fluoropolymer molecules to cross-link and to form a network. Suitable organic peroxides are those which generate free radicals at curing temperatures. A dialkyl peroxide or a bis(dialkyl peroxide) which decomposes at a temperature above the extrusion temperature may be useful. A di-tertiarybutyl peroxide having a tertiary carbon atom attached to the peroxy oxygen, for example, may be useful. Among the peroxides of this type are 2,5-dimethyl-2,5-di(tertiarybutylperoxy)hexyne-3 and 2,5-dimethyl-2,5-di(tertiarybutylperoxy)hexane. Other peroxides useful for making fluoroelastomers can be selected from compounds such as dicumyl peroxide, dibenzoyl peroxide, tertiarybutyl perbenzoate, alpha,alpha′-bis(t-butylperoxy-diisopropylbenzene), and di[1,3-dimethyl-3-(t-butylperoxy)-butyl]carbonate. A tertiary butyl peroxide having a tertiary carbon atom attached to a peroxy oxygen may be a useful class of peroxides. Further examples of peroxides include 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; di(t-butylperoxy-isopropyl)benzene; t-butyl peroxy isopropylcarbonate, t-butyl peroxy 2-ethylhexyl carbonate, t-amyl peroxy 2-ethylhexyl carbonate, 1-hexylperoxy isopropyl carbonate, di[1l 3-dimethyl-3-(t-butylperoxy)butyl] carbonate, carbonoperoxoic acid, O,O′-1,3-propanediyl OO,OO′-bis(1,1-dimethylethyl) ester, and combinations thereof. The amount of peroxide curing agent used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of the fluoropolymer may be used.

The curing agents may be present on carriers, for example, silica containing carriers.

A peroxide cure system may also include one or more coagent. Typically, the coagent includes a polyunsaturated compound which is capable of cooperating with the peroxide to provide a useful cure. These coagents can be added in an amount between 0.1 and 10 parts per hundred parts fluoropolymer, in some embodiments between 2 and 5 parts per hundred parts fluoropolymer. Examples of useful coagents include tri(methyl)allyl isocyanurate (TMAIC), triallyl isocyanurate (TAIC), tri(methyl)allyl cyanurate, poly-triallyl isocyanurate (poly-TAIC), triallyl cyanurate (TAC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Another useful coagent may be represented by the formula CH₂═CH—Rfl-CH═CH₂ wherein Rfl may be a perfluoroalkylene having from 1 to 8 carbon atoms. Such coagents can provide enhanced mechanical strength to the final cured elastomer.

Curing of composition including a fluoropolymer having nitrogen-containing cure sites can also be modified by using yet other types of curatives to achieve a dual cure system. Examples of such curatives for fluoropolymers with nitrile cure sites include fluoroalkoxy organophosphohium, organoammonium, or organosulfonium compounds (e.g., Int. Pat. Appl. Pub. No. WO 2010/151610 (Grootaert et al.), bis-aminophenols (e.g., U.S. Pat. Nos. 5,767,204 (Iwa et al.) and 5,700,879 (Yamamoto et al.)), bis-amidooximes (e.g., U.S. Pat. No. 5,621,145 (Saito et al.)), and ammonium salts (e.g., U.S. Pat. No. 5,565,512 (Saito et al.)). In addition, organometallic compounds of arsenic, antimony, and tin (e.g., allyl-, propargyl-, triphenyl-allenyl-, and tetraphenyltin and triphenyltin hydroxide) as described in U.S. Pat. Nos. 4,281,092 (Breazeale) and 5,554,680 (Ojakaar) and ammonia-generating compounds may be useful. “Ammonia-generating compounds” include compounds that are solid or liquid at ambient conditions but that generate ammonia under conditions of cure. Examples of such compounds include hexamethylenetetramine (urotropin), dicyandiamide, and metal-containing compounds of the formula A^{w+}(NH₃)ₓY^{w-}, wherein A^{w+} is a metal cation such as Cu^{l}, Co²⁺, Co³⁺, Cu⁺, and Ni²⁺; w is equal to the valance of the metal cation; Y^{w-} is a counterion (e.g., a halide, sulfate, nitrate, acetate); and x is an integer from 1 to about 7. Further examples include substituted and unsubstituted triazine derivatives such as those of the formula:

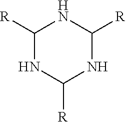

wherein R is a hydrogen atom or a substituted or unsubstituted alkyl, aryl, or arylalkylene group having from 1 to about 20 carbon atoms. Specific useful triazine derivatives include hexahydro-1,3,5-s-triazine and acetaldehyde ammonia trimer.

The curable composition may further contain acid acceptors. Acid acceptors may be added to improve the fluoroelastomer's steam and water resistance. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. However, some applications like fuel cell sealants or gaskets for the semi-conductor industry require low metal content. Accordingly, in some embodiments, the composition is free of such acid acceptors or includes an amount of these acid acceptors such that the composition has less than 1 ppm total metal ion content.

In some embodiments, an acid acceptor is used between 0.5 and 5 parts per 100 parts of the curable composition. In other embodiments, an acid acceptor is not needed and the composition is essentially free of an acid acceptor. As used herein, essentially free of an acid acceptor or essentially free of a metal-containing acid acceptor means less than 0.01, 0.005, or even 0.001 parts per 100 parts of the composition according to the present disclosure and includes being free of an acid acceptor.

The three-dimensional article first produced upon exposure to at least the first irradiation dosage and the second irradiation dosage is often referred to as a “green body”, as described above. When the composition is an aqueous dispersion, the green body typically is in the form of an aqua gel. The green body is typically removed from the source of radiation, may be removed from the substrate, if desired, and may be separated from the unreacted composition using any of the methods described above in connection with FIGS. 4 to 15. The unreacted composition may be discarded or reused in another three-dimensional article.

Regardless of whether the compositions comprises water, organic solvent, or a combination thereof us a dispersing medium, the dispersing medium is typically removed from the green body. In other words, the green body is typically dried. Advantageously, the drying can be carried out to ensure that the entirety of the green body dries as uniformly as possible. Drying is typically carried out slowly to avoid the formation of cracks or tilts in the object. The drying can be carried out, for example, at room temperature for 12 hours to 24 hours or by using a vacuum oven (e.g., using temperatures from 30° C. to 80° C. or from 40° C. to 70° C. and pressures between 760 Torr and 1×10³ Torr). Drying under controlled humidity for example under 50% to 90% humidity, may also be useful. The drying conditions may depend, for example, on the dispersing medium used in the composition and on the size and geometry of the green body generated.

Curing a curable fluoropolymer is also typically achieved by heat-treating the green body, either in a separate or parallel heating regime. The heat-treatment is carried out at an effective temperature and effective time to create a cured fluoroelastomer. Optimum conditions can be tested by examining the cured fluorinated elastomer for its mechanical and physical properties. Typically, curing is carried out at temperatures greater than 120° C. or greater than 150° C. Typical curing conditions include curing at temperatures between 160° C. and 210° C. or between 160′C and 190° C. Typical curing periods include from 3 to 90 minutes. Curing may be carried out under pressure. For example pressures from 10 to 100 bar may be applied. A post curing cycle may be applied to ensure the curing process is fully completed. Post curing may be carried out at a temperature between 170° C. and 250° C. for a period of 1 to 24 hours.

The polymerized binder material may be removed from the green body in a heating regime, which may be subsequent to or simultaneous with the drying and optionally curing described above. Conveniently this is carried out by a heat treatment to degrade (for example by oxidization or combustion) and/or evaporate the polymerized material. The temperatures may be chosen such that the fluoropolymer does not melt or get destroyed, or for non-melt processable fluoropolymers heating above the melting point may be carried out. Typically, the article turns black during the combustion of the polymerized binder. Typically, removing the binder material is carried out at temperatures greater than 250° C. or greater than 300° C. Typical thermal decomposition conditions include heating at temperatures between 300° C. and 380′C or between 300° C. and 375° C. Typical thermal decomposition periods include from 12 hours to 96 hours.

In some embodiments, the three-dimensional article may be heated to sinter the fluoropolymer particles. The heating regime for sintering may be subsequent to or simultaneous with the drying and thermal decomposition of the binder described above. The heat treatment may depend on the melt flow index of the fluoropolymer used. Heat treatment of up to 20° C., up to 400 or even up to 60° C. above the melting point of the fluoropolymer. However, the temperature is selected to be below the degradation temperature of the fluoropolymer. The remaining binder material burns off at the sintering step and the article turns white. Typically, sintering is carried out at temperatures greater than 350° C. or greater than 375° C. Typical sintering conditions include heating at temperatures between 350° C. and 425° C. or between 350° C. and 400° C. Typical sintering periods include from 12 hours to 120 hours. If the temperature is set too high or the time too long, the article may deform. In such case a lower temperature or shorter time period should be used. For non-melt processable fluoropolymers, the fluoropolymer particles will fuse but because of the extremely high melt-viscosity of these polymers, they will advantageously retain their shape.

Through sintering, the density of the three-dimensional article can be advantageously increased. However, the sintering can be controlled such that the binder material does not completely burn off and residual amounts remain in the article. The presence of residual degraded binder material may add some properties to the article that may be desirable for some applications. This is advantageous for removing binder material by heat treatment and to provide dense fluoropolymer articles. Three-dimensional fluoropolymer articles, in some embodiments PTFE articles, where the fluoropolymer has a density of more than 2.00 g/cm³, for example between 2.05 g/cm³ and 2.11 g/cm³ may be obtained by the processes disclosed herein. In one embodiment the fluoropolymer article has a density of from 2.13 g/cm³ to 2.17 g/cm³.

The final article typically has the same shape as the green body, although some shrinking compared to the green body may be observed. By doing controls and test runs the amount of shrinking can be accounted for when programming the source of radiation. Shrinking may be minimized by maximizing the fluoropolymer content of the composition, as described above. A higher comonomer content in a TFE copolymer, in particular perfluorinated vinyl ether and perfluorinated allyl ether content, may also lead to a reduced shrinking.

In some embodiments, the three-dimensional fluoropolymer article obtained after sintering has surprisingly few voids. Without being bound by theory, it is believed that during the sintering step the fluoropolymer particles have fused together thus eliminating voids created by removing the binder. It is also believed that small particle size of fluoropolymers in the compositions may be useful for creating dense three-dimensional fluoropolymer articles as characterized by a low void content. Three-dimensional articles can be obtained that have a void content of less than 20% (200‰), in some embodiments, less than 10% (100‰) or less than 2% (20‰). For example, three-dimensional fluoropolymer articles can be provided having a void content between 0.1 and 1.5% (1 and 15‰), between 2.2 to 5.5% (22 and 55‰), between 6.0 to 12.0% (60 to 120‰) or between 12.5 to 18.5% (125 to 185‰). In some embodiments, the three-dimensional article has a void content (Voi) of from 1 ‰ to 55‰). In some embodiments, the three-dimensional article has a stretch void index (SVI) at an elongation of 200% or 100% of less than 200, or less than 100, or less than 9.

Three-dimensional fluoropolymer articles according to the present disclosure and/or made according to the methods of the present disclosure may be useful on their own and may also be components of other articles. Three-dimensional articles of different shapes, designs and functions may be obtained. Examples of the three-dimensional articles include bearings, for example friction bearings or piston bearings, gaskets, shaft seals, ring lip seals, washer seals, O-rings, grooved seals, valves and valve seats, connectors, lids and containers. The three-dimensional articles may be useful as medical implants, chemical reactors, screws, cogwheels, joints, bolts, pumps, electrodes, heat exchangers, mixers, turbines, electrical transformers, electrical insulators, and extruders, and the three-dimensional articles may be components of other articles including the above articles. The three-dimensional articles may be useful in applications where resistance to acids, bases, fuels, and/or hydrocarbons is desirable, where non-stick properties are desirable, where heat resistance is desirable, and combinations thereof. The three-dimensional object prepared by the method according to the present disclosure may be an article useful in a variety of industries, for example, the aerospace, apparel, architecture, automotive, business machines products, consumer, defense, dental, electronics, educational institutions, heavy equipment, jewelry, medical, and toys industries.

As the compositions disclosed herein may comprise fillers and one or more other ingredients, as described above, three-dimensional fluoropolymer articles according to the present disclosure and/or made according to the methods of the present disclosure may contain one or more fillers or one or more other ingredients. Examples of fillers and other ingredients are any of those described above. Further examples of fillers include glass fibers, ceramic fibers, and polyaramide fibers. In some embodiments, the three-dimensional fluoropolymer articles comprise from 50% to 100% of the fluoropolymers. In some embodiments, the three-dimensional fluoropolymer articles comprise at least one filler. In some of these embodiments, the amount of fillers may be up to 1%, or up to 10%, or up to 50% by weight based on the total weight of the three-dimensional fluoropolymer article.

Fluoropolymer articles of a variety of sizes can be produced by the method according to the present disclosure. Articles of small dimensions may be conveniently produced by the methods described herein in connection, for example, with FIGS. 6 to 9, described above. A three-dimensional article can be prepared having a longest axis (as the case may be this may also be a diameter) that is smaller than 1.0 centimeter (cm) or even smaller than 0.7 mm. In some embodiments, small three-dimensional articles may be produced having a longest axis or diameter of from about 0.01 to about 1.0 mm, or from 0.7 to 1.5 cm. In some embodiment, three-dimensional articles may be produced, for example articles having a smallest axis or diameter of at least 1.1 mm.

It is an advantage of the method of the present disclosure that non-melt-processable fluoropolymers can be shaped into articles having geometries and designs that could not easily be produced by machining with shaping tools. For example, the three-dimensional article can be a structured film. Accordingly, the present disclosure provides a structured film comprising a non-melt-processable fluoropolymer, in which the structured film includes a first portion and a second portion, each having different heights. The three-dimensional articles according to the present disclosure and/or made according to the method disclosed herein may differ from those shaped by conventional methods in that their surfaces do not show any marks from shaping tools. This can be determined, for example, by optical microscopy or raster electron microscopy.

In some embodiments, the structured film comprises upstanding surface structures on a backing. The upstanding surface structures can be discrete (e.g., posts) or continuous (e.g., ridges) in one direction across the film and may have a variety of sizes and shapes. For example, the cross-sectional shape of the upstanding surface structure may be a polygon (e.g., square, rectangle, rhombus, hexagon, pentagon, or dodecagon), which may be a regular polygon or not, or the cross-sectional shape of the post may be curved (e.g, round or elliptical). The discrete surface structure may taper from its base to its distal tip.

The surface structures may have a cross-section with a maximum width dimension “w” of at least 30 micrometers, 50 micrometers, 70 micrometers, 100 micrometers, or 125 micrometers. The width of the surface structures may be up to 1 millimeter in some embodiments. In some embodiments, the surface structures have a cross-section with a width dimension “w” in a range from 50 micrometers to 550 micrometers or 100 micrometers to 400 micrometers. The term “width dimension” should be understood to include the diameter of a surface structure with a circular cross-section. The surface structure may have more than one width dimension (e.g., in a rectangular or elliptical cross-section shaped post). In the case of surface structures that are continuous across the film in one direction (e.g., ridges as shown in FIG. 5) the width generally refers to the discontinuous dimension. Furthermore, in cases where the surface structure tapers, for example, from the proximal end at the base toward the distal end, the width of the surface structure is considered to be its greatest width.

In some embodiments, the surface structures are spaced apart on a backing. The term “spaced-apart” refers to surface structures that are formed to have a distance between them. The bases of “spaced-apart” surface structures, where they are attached to the backing, do not touch each other. The backing in these embodiments may be considered to be an unstructured film region or as an aggregate of unstructured film regions. Spaced-apart surface structures may have a density, in some embodiments, of at least 10 per square centimeter (cm²) (63 per square inch in²). For example, the initial density of the spaced-apart surface structures may be at least 100/cm² (635/in²), 248/cm² (1600/in²), 394/cm² (2500/in²), or 550/cm² (3500/in²). In some embodiments, the density of the spaced-apart surface structures may be up to 1575/cm² (10000/in²) up to about 1182/cm² (7500/in²), or up to about 787/cm² (5000/in²). Initial densities in a range from 10/cm³ (63/in²) to 1575/cm² (10000/in²) or 100/cm² (635/in²) to 1182/cm² (7500/in²) may be useful, for example. The spacing of the spaced-apart surface structures need not be uniform.

The surface structures may be provided in a variety of patterns. For example, there may be groups of surface structures clustered together, with separation between the clusters. In these embodiments, the space between the clusters (that is, the backing) may be considered to be an unstructured film region.

In some embodiments, the surface structures are continuous in at least one direction of the film but may be spaced apart in another direction of the film. For example, the surface structures may be continuous ridges spaced apart on a film backing as shown in FIG. 5. The space between adjacent edges of the ridges may be at least 0.5 mm or at least 0.63 mm. The space between adjacent edges of the ridges may be up to 1 mm or 2 mm. The backing in these embodiments may be considered to be an unstructured film region or as an aggregate of unstructured film regions.

In some embodiments, the surface structures are generally not spaced apart. For example, the structured film may have a series of alternating, abutting upstanding and inverted pyramids in two directions of the film. In another example, the structured film may have a series of alternating, abutting ridges and grooves (that is, peaks and valleys) extending in one direction on the surface of the film. In some embodiments, the film may include one or more unstructured film region separating regions of abutting surface structures.

The structured films according to and/or made according to the present disclosure may include more than one kind of surface structure (e.g., any of the surface structures described above). For example, the structured film may have a combination of continuous ridges and upstanding discrete structures or a combination of projections and indentations.

Irradiation in the method disclosed herein typically does not provide structures with overhangs. If desired, the distal ends of the upstanding surface structures may be changes after the irradiation, for example, by a capping method as described in U.S. Pat. No. 5,077,870 (Melbye et al.). Typically, the capping method includes deforming the tip portions of upstanding surface structures using heat and/or pressure. The heat and pressure, if both are used, could be applied sequentially or simultaneously. In this way, upstanding surface structures on a backing may be made to have distal ends with overhanging portions. The formation of upstanding surface structures can also include a step in which the shape of the distal end is changed, for example, as described in U.S. Pat. No. 6,132,660 (Kampfer).

In the structured film according to and/or made according to the present disclosure wherein the surface structures are spaced apart on or within a backing, the backing may have a variety of thicknesses. For example, the thickness of the backing may be up to about 750, 500, 400, 250, or 150 micrometers, depending on the desired application. In some embodiments, the thickness of the backing is at least about 50, 75, or 100 micrometers, depending on the desired application. In some embodiments, the thickness of the backing is in a range from 50 to about 225 micrometers, from about 75 to about 200 micrometers, or from about 100 to about 150 micrometers. The backing may be continuous (i.e., without any through-penetrating openings) or discontinuous (e.g. comprising through-penetrating openings). In cases of a discontinuous backing, the thickness of the backing at the opening is zero. In some embodiments, the multiple surface structures have a maximum height (above the backing) of up to 3 millimeters (mm), 2 mm, 1.5 mm, 1 mm, or 0.5 mm and, in some embodiments, a minimum height of at least 0.025 mm, 0.05 mm, 0.075 mm, 0.1 mm, or 0.2 mm.

Structured films according to the present disclosure and/or made according to the method of the present disclosure may have a variety of shapes and sizes. Structured film webs may be made, for example, using the continuous methods described above in connection with FIGS. 10 to 15. It is also envisioned that structured films can be prepared using batch processes (e.g., as shown in connection with FIGS. 6 to 9). The structured film may have any suitable dimension, but length (L) and width (W) dimensions of at least 10 cm may be useful in some embodiments.

The three-dimensional articles disclosed herein can be produced by the additive processing as described herein having mechanical properties comparable to fluoropolymer articles prepared by conventional machining. Shaped fluoropolymers (e.g., non-melt-processable fluoropolymers) can be produced by the method of the present disclosure having a tensile strength of from at least 5 MPa, for example, from 12 to 24 MPa (DIN EN ISO 12086-2) and an elongation at break of at least 100% for example, an elongation at break of 150 to 400% (DIN EN ISO 12086-2 with a pulling rate of 50 mm/min).

Three-dimensional fluoropolymer articles made by the method disclosed herein can have a specific density of more than 2.05 g/cm without applying any pressure (e.g., made at ambient pressure (I bar) or reduced pressure). As a result, in some embodiments, the articles may not be oriented and may be essentially isotropic, at least in two of the three spatial directions. For example, shaped fluoropolymers can be prepared by the methods provided herein, that have a degree of orientation of less than 20%, or even less than 10% or even less than 5% (as determined by polarized light microscopy). This presents another advantage of the methods of the present disclosure. Fluoropolymers with a low MFI, for example below 50 g/10 min (MFI 372/5), including non-melt-processable fluoropolymers described above, are conventionally shaped by subjecting the fluoropolymer to high pressure and usually high temperatures. As a result the shaped fluoropolymer is oriented (anisotropic) and the shaped fluoropolymer may have different mechanical properties in different directions (e.g. different properties in the longitudinal and transverse direction).

In some embodiments, a shaped fluoropolymer may be provided that is essentially isotropic regarding its tensile strength and/or elongation at break, which means the fluoropolymer has essentially the same properties in at least two of all three spatial orientations (x-, y-, and z-direction, x being the longitudinal direction, y being the transversal direction and z being perpendicular to the x and y direction), or the properties deviate by less than 50% or less than 20%, less than 10%, less than 5%, or less than 1%.

Another advantage of the method disclosed herein is that three-dimensional articles including fillers may be prepared that are essentially isotropic with respect to the distribution of the fillers. Fillers of non-spherical shapes tend to become oriented when shaping non-melt-processable fluoropolymers with conventional shaping methods. Examples of such fillers include carbon fibers, glass fibers, ceramic fibers, polyaramide fibers, boron nitride, aluminum oxides and aluminum oxide containing fillers, graphite, and carbon nanotubes. With the method of the present disclosure, such fillers may be distributed randomly in the fluoropolymer three-dimensional article rather than becoming oriented. The distribution of fillers can be determined by optical or electronic microscopy of samples.

Another advantage of the method disclosed herein is that three-dimensional articles including electronically conductive fillers may be prepared that are essentially isotropic with regard to their electronically conductive properties. Examples of suitable electronically conductive fillers include graphite and carbon nanotubes. Electrical Conductivity and electrical volume resistivity can be measured, for example, in accordance with ASTM F84-98 as published in November 1998.

Another advantage of the method disclosed herein is that three-dimensional articles including thermally conductive fillers may be prepared that are essentially isotropic with respect to thermal conductivity. Examples of suitable thermally conductive fillers include graphite and boron nitride. Thermal conductivity and thermal resistivity can be determined, for example, according to ASTM E1461-13 (published in October 2013).

### Some Embodiments of the Disclosure

In a first embodiment, the present disclosure provides a method of making a three-dimensional article, the method comprising:

obtaining a composition disposed on a surface of a substrate, the composition comprising fluoropolymer particles and a binder material that is polymerizable upon exposure to actinic or particle radiation, wherein the substrate is transparent to the actinic or particle radiation;

irradiating a first portion of the composition through the substrate for a first irradiation dosage; and

irradiating a second portion of the composition through the substrate for a second irradiation dosage, wherein the first portion and the second portion are adjacent to or overlapping with each other, and wherein the first irradiation dosage is different from the second irradiation dosage,

wherein irradiating the first portion of the composition and the second portion of the composition polymerizes the binder material and forms a three-dimensional article having a first portion and a second portion on the surface of the substrate, wherein the first portion of the three-dimensional article has a different thickness in an axis normal to the surface of the substrate than the second portion of the three-dimensional article.

In a second embodiment, the present disclosure provides the method of the first embodiment, wherein in the first portion and the second portion of the three-dimensional article, the binder material in contact with the substrate is polymerized. In general, there is no non-polymerized binder material between the substrate and the first portion and the second portion of the three-dimensional article in any line normal to the surface of the substrate passing through the first portion or the second portion.

In a third embodiment, the present disclosure provides the method of the second embodiment, wherein the substrate comprises at least one of polyethylene terephthalate, polyethylene naphthalate, polycarbonate, polyimide, cycloolefin, poly(methyl methacrylate), glass, a release liner, or a fluoropolymer.

In a fourth embodiment, the present disclosure provides the method of the any one of the first to third embodiments, wherein the first portion of the three-dimensional article has a fraction of the thickness of the first portion of the composition, wherein the second portion of the three-dimensional article has a fraction of the thickness of the second portion of the composition, and wherein at least one of the fraction of the thickness of the first portion of the composition or the fraction of the thickness of the second portion of the composition is less than 1.

In a fifth embodiment, the present disclosure provides the method of the any one of the first to fourth embodiments, wherein first irradiation dosage and the second irradiation dosage differ in at least one of time or radiation intensity.

In a sixth embodiment, the present disclosure provides the method of any one of the first to fifth embodiments, wherein irradiating the first portion and irradiating the second portion occur simultaneously.

In a seventh embodiment, the present disclosure provides the method of any one of the first to sixth embodiments, further comprising removing at least a portion of the composition comprising the fluoropolymer particles and the binder material in which the binder material is not polymerized after the irradiating.

In an eighth embodiment, the present disclosure provides the method of any one of the first to seventh embodiments, wherein at least one of the first irradiation dosage or second irradiation dosage is provided by at least one of ultraviolet light, visible light, X rays, gamma radiation, ion beam, electronic beam.

In a ninth embodiment, the present disclosure provides the method of any one of the first to eighth embodiments, wherein at least one of the first irradiation dosage or the second irradiation dosage is provided by a digital light processor with a light emitting diode (LED), a digital light processor with a lamp, a laser scanning device with a laser, a liquid crystal display (LCD) panel with a backlight, a photomask with a lamp, or a photomask with an LED.

In a tenth embodiment, the present disclosure provides the method of any one of the first to ninth embodiments, further comprising:

moving at least one of the substrate or a radiation source; and subsequently

irradiating a third portion of the composition for a third irradiation dosage.

In an eleventh embodiment, the present disclosure provides the method of any one of the first to tenth embodiments, wherein the three-dimensional article is a continuous web.

In a twelfth embodiment, the present disclosure provides the method of any one of the first to eleventh embodiments, further comprising removing the three-dimensional article from the substrate.

In a thirteenth embodiment, the present disclosure provides the method of any one of the first to twelfth embodiments, wherein the binder material comprises at least one of a carbon-carbon double bond, a carbon-carbon triple bond, an epoxide, a silane, or a combination of hydroxyl groups and at least one of ester groups or isocyanate groups.

In a fourteenth embodiment, the present disclosure provides the method of any one of the first to thirteenth embodiments, wherein the binder material comprises at least one of an acrylate group or a methacrylate group.

In a fifteenth embodiment, the present disclosure provides the method of any one of the first to fourteenth embodiments, wherein the composition comprises at least one of water or organic solvent.

In a sixteenth embodiment, the present disclosure provides the method of the fifteenth embodiment, wherein the method includes removing the at least one of water or organic solvent.

In a seventeenth embodiment, the present disclosure provides the method of any one of the first to sixteenth embodiments, wherein the composition further comprises at least one of a photoinitiator, a free-radical inhibitor, or an optical brightener.

In an eighteenth embodiment, the present disclosure provides the method of any one of the first to seventeenth embodiments, wherein the fluoropolymer particles comprise interpolymerized units from at least one partially fluorinated or perfluorinated ethylenically unsaturated monomer represented by formula RCF═CR₃, wherein each R is independently fluoro, chloro, bromo, hydrogen, a fluoroalkyl group having up to 8 carbon atoms and optionally interrupted by one or more oxygen atoms, a fluoroalkoxy group having up to 8 carbon atoms and optionally interrupted by one or more oxygen atoms, alkyl having up to 10 carbon atoms, alkoxy having up to 8 carbon atoms, or aryl having up to 8 carbon atoms.

In a nineteenth embodiment, the present disclosure provides the method of any one of the first to eighteenth embodiments, wherein the fluoropolymer particles comprise a non-melt-processable fluoropolymer.

In a twentieth embodiment, the present disclosure provides the method of the nineteenth embodiment, wherein the fluoropolymer particles comprise at least one of polytetrafluoroethylene or a copolymer of tetrafluoroethylene and at least one of hexafluoropropylene, chlorotrifluoroethylene, a perfluoroalkyl vinyl ether, or a perfluoroalkyl allyl ether.

In a twenty-first embodiment, the present disclosure provides the method of any one of the first to eighteenth embodiments, wherein the fluoropolymer particles comprise an amorphous fluoropolymer.

In a twenty-second embodiment, the present disclosure provides the method of the twenty-first embodiment, wherein the amorphous fluoropolymer comprises interpolymerized units of at least one of vinylidene fluoride, tetrafluoroethylene, hexafluoropropylene, chlorotrifluoroethylene, 2-chloropentafluoropropene, dichlorodifluoroethylene, 1,1-dichlorofluoroethylene, 1-hydropentafluoropropylene, 2-hydropentafluoropropylene, a perfluoroalkylvinyl ether, a perfluoroalkylallyl ether, a perfluorinated 1,3-dioxole optionally substituted by perfluoroC₁₋₄alkyl or perfluoroC₁₋₄alkoxy, poly(perfluoro-4-vinyloxy-1-butene), poly(perfluoro-4-vinyloxy-3-methyl-1-butene), or a perfluoro-2-methylene-1,3-dioxolane that is unsubstituted, substituted by at least one of perfluoroC₁₋₄alkyl or perfluoroC₁₋₄alkoxyC₁₋₄alkyl, or fused to a 5- or 6-membered perfluorinated ring optionally containing one oxygen atom.

In a twenty-third embodiment, the present disclosure provides the method of any one of the first to eighteenth embodiment, wherein the fluoropolymer particles comprise a fluorotothermoplastic.

In a twenty-fourth embodiment, the present disclosure provides the method of the twenty-third embodiment, wherein the fluorothermoplastic comprises interpolymerized units of at least one of vinylidene fluoride, tetrafluoroethylene, hexafluoropropylene, chlorotrifluoroethylene, 2-chloropentafluoropropene, dichlorodifluoroethylene, 1,1-dichlorofluoroethylene, 1-hydropentafluoropropylene, 2-hydropentafluoropropylene, a perfluorovinyl ether, or a perfluoroallyl ether.

In a twenty-fifth embodiment, the present disclosure provides the method of any one of the first to twenty-fourth embodiments, wherein the fluoropolymer particles are curable, the composition further comprising a curing agent.

In a twenty-sixth embodiment, the present disclosure provides the method of any one of the first to twenty-fifth embodiments, wherein the composition comprises at least 30 percent by weight of the fluoropolymer particles, based on the total weight of the composition.

In a twenty-seventh embodiment, the present disclosure provides the method of any one of the first to twenty-sixth embodiments, wherein the composition comprises at least 50 percent by weight of the fluoropolymer particles, based on the total weight of the composition.

In a twenty-eighth embodiment, the present disclosure provides the method of any one of the first to twenty-seventh embodiments, wherein the composition further comprises inorganic filler.

In a twenty-ninth embodiment, the present disclosure provides a method of making a three-dimensional article, the method comprising:

obtaining a composition disposed on a surface of a substrate, the composition comprising fluoropolymer particles and a binder material that is polymerizable upon exposure to actinic or particle radiation, wherein the substrate is transparent to the actinic or particle radiation; and

irradiating at least a portion of the composition through the substrate for an irradiation dosage;

wherein irradiating the portion of the composition polymerizes the binder material and forms at least a portion of a three-dimensional article, wherein the portion of the three-dimensional article has a fraction of the thickness of the portion of the composition, wherein the fraction of the thickness is less than 1, and wherein in the portion of the three-dimensional article, the binder material in contact with the substrate is polymerized.

In a thirtieth embodiment, the present disclosure provides the method of the twenty-ninth embodiment, wherein the substrate comprises at least one of polyethylene terephthalate, polyethylene naphthalate, polycarbonate, polyimide, cycloolefin, poly(methyl methacrylate), glass, a release liner, or a fluoropolymer.

In a thirty-first embodiment, the present disclosure provides the method of the twenty-ninth or thirtieth embodiments, further comprising irradiating a second portion of the composition through the substrate for a second irradiation dosage, wherein the first portion and the second portion are adjacent to or overlapping with each other, and wherein the first irradiation dosage is different from the second irradiation dosage.

In a thirty-second embodiment, the present disclosure provides the method of the thirty-first embodiment, wherein first irradiation dosage and the second irradiation dosage differ in at least one of time or radiation intensity.

In a thirty-third embodiment, the present disclosure provides the method of thirty-first or thirty-second embodiments, wherein irradiating the first portion and irradiating the second portion occur simultaneously.

In a thirty-fourth embodiment, the present disclosure provides the method of any one of the first to sixth embodiments, further comprising removing at least a portion of the composition comprising the fluoropolymer particles and the binder material in which the binder material is not polymerized after the irradiating.

In a thirty-fifth embodiment, the present disclosure provides the method of any one of the twenty-ninth to thirty-fourth embodiments, wherein at least one of the first irradiation dosage or second irradiation dosage is provided by at least one of ultraviolet light, visible light X rays, gamma radiation, ion beam, electronic beam.

In a thirty-sixth embodiment, the present disclosure provides the method of any one of the twenty-ninth to thirty-fifth embodiments, wherein at least one of the first irradiation dosage or the second irradiation dosage is provided by a digital light processor with a light emitting diode (LED), a digital light processor with a lamp, a laser scanning device with a laser, a liquid crystal display (LCD) panel with a backlight, a photomask with a lamp, or a photomask with an LED.

In a thirty-seventh embodiment, the present disclosure provides the method of any one of the twenty-ninth to thirty-sixth embodiments, further comprising:

moving at least one of the substrate or a radiation source; and subsequently

irradiating a third portion of the composition for a third irradiation dosage.

In a thirty-eighth embodiment, the present disclosure provides the method of any one of the twenty-ninth to thirty-seventh embodiments, wherein the three-dimensional article is a continuous web.

In a thirty-ninth embodiment, the present disclosure provides the method of any one of the twenty-ninth to thirty-eighth embodiments, further comprising removing the three-dimensional article from the substrate.

In a fortieth embodiment, the present disclosure provides the method of any one of the twenty-ninth to thirty-ninth embodiments, wherein the binder material comprises at least one of a carbon-carbon double bond, a carbon-carbon triple bond, an epoxide, a silane, or a combination of hydroxyl groups and at least one of ester groups or isocyanate groups.

In a forty-first embodiment, the present disclosure provides the method of any one of the twenty-ninth to fortieth embodiments, wherein the binder material comprises at least one of an acrylate group or a methacrylate group.

In a forty-second embodiment, the present disclosure provides the method of any one of the twenty-ninth to forty-first embodiments, wherein the composition comprises at least one of water or organic solvent.

In a forty-third embodiment, the present disclosure provides the method of the forty-second embodiment, wherein the method includes removing the at least one of water or organic solvent.

In a forty-forth embodiment, the present disclosure provides the method of any one of the twenty-ninth to forty-third embodiments, wherein the composition further comprises at least one of a photoinitiator, a free-radical inhibitor, or an optical brightener.

In a forty-fifth embodiment, the present disclosure provides the method of any one of the twenty-ninth to forty-fourth embodiments, wherein the fluoropolymer particles comprise interpolymerized units from at least one partially fluorinated or perfluorinated ethylenically unsaturated monomer represented by formula RCF═CR₂, wherein each R is independently fluoro, chloro, bromo, hydrogen, a fluoroalkyl group having up to 8 carbon atoms and optionally interrupted by one or more oxygen atoms, a fluoroalkoxy group having up to 8 carbon atoms and optionally interrupted by one or more oxygen atoms, alkyl having up to 10 carbon atoms, alkoxy having up to 8 carbon atoms, or aryl having up to 8 carbon atoms.

In a forty-sixth embodiment, the present disclosure provides the method of any one of the twenty-ninth to forty-fifth embodiments, wherein the fluoropolymer particles comprise a non-melt-processable fluoropolymer.

In a forty-seventh embodiment, the present disclosure provides the method of the forty-sixth embodiment, wherein the fluoropolymer particles comprise at least one of polytetrafluoroethylene or a copolymer of tetrafluoroethylene and at least one of hexafluoropropylene, chlorotrifluoroethylene, a perfluoroalkyl vinyl ether, or a perfluoroalkyl allyl ether.

In a forty-eighth embodiment, the present disclosure provides the method of any one the twenty-ninth to forty-seventh embodiments, wherein the fluoropolymer particles comprise an amorphous fluoropolymer.

In a forty-ninth embodiment, the present disclosure provides the method of the forty-eighth embodiment, wherein the amorphous fluoropolymer comprises interpolymerized units of at least one of vinylidene fluoride, tetrafluoroethylene, hexafluoropropylene, chlorotrifluoroethylene, 2-chloropentafluoropropene, dichlorodifluoroethylene, 1,1-dichlorofluoroethylene, 1-hydropentafluoropropylene, 2-hydropentafluoropropylene, a perfluoroalkylvinyl ether, a perfluoroalkylallyl ether, a perfluorinated 1,3-dioxole optionally substituted by perfluoroC₁₋₄alkyl or perfluoroC₁₋₄alkoxy, poly(perfluoro-4-vinyloxy-1-butene), poly(perfluoro-4-vinyloxy-3-methyl-1-butene), or a perfluoro-2-methylene-1,3-dioxolane that is unsubstituted, substituted by at least one of perfluoroC₁₋₄alkyl or perfluoroC₁₋₄alkoxyC₁₋₄alkyl, or fused to a 5- or 6-membered perfluorinated ring optionally containing one oxygen atom.

In a fiftieth embodiment, the present disclosure provides the method of any one of the twenty-ninth to forty-ninth embodiment, wherein the fluoropolymer particles comprise a fluorothermoplastic.

In a fifty-first embodiment, the present disclosure provides the method of the fiftieth embodiment, wherein the fluorothermoplastic comprises interpolymerized units of at least one of vinylidene fluoride, tetrafluoroethylene, hexafluoropropylene, chlorotrifluoroethylene, 2-chloropentafluoropropene, dichlorodifluoroethylene, 1,1-dichlorofluoroethylene, 1-hydropentafluoropropylene, 2-hydropentafluoropropylene, a perfluorovinyl ether, or a perfluoroallyl ether.

In a fifty-second embodiment, the present disclosure provides the method of any one of the twenty-ninth to fifty-first embodiments, wherein the fluoropolymer particles are curable, the composition further comprising a curing agent.

In a fifty-third embodiment, the present disclosure provides the method of any one of the twenty-ninth to fifty-second embodiments, wherein the composition comprises at least 30 percent by weight of the fluoropolymer particles, based on the total weight of the composition.

In a fifty-fourth embodiment, the present disclosure provides the method of any one of the twenty-ninth to fifty-third embodiments, wherein the composition comprises at least 50 percent by weight of the fluoropolymer particles, based on the total weight of the composition.

In a fifty-fifth embodiment, the present disclosure provides the method of any one of the twenty-ninth to fifty-fourth embodiments, wherein the composition further comprises inorganic filler.

In a fifty-sixth embodiment, the present disclosure provides the method of any one of the first to fifty-fifth embodiments, further comprising:

retrieving, from a non-transitory machine readable medium, data representing a model of the three-dimensional article;

executing, by one or more processors interfacing with a manufacturing device, manufacturing instructions using the data; and

generating, by the manufacturing device, the three-dimensional article.

In a fifty-seventh embodiment, the present disclosure provides a three-dimensional article made by the method of any one of the first to fifty-sixth embodiments.

In a fifty-eighth embodiment, the present disclosure provides the three-dimensional article of the fifty-seventh embodiment, wherein the three-dimensional article comprises at least one of a friction bearings or piston bearing, gasket, shaft seal, ring lip seal, washer seal, O-ring, grooved seal, valve or valve seat, connector, lid, container, or structured film.

In a fifty-ninth embodiment, the present disclosure provides a structured film comprising a non-melt-processable fluoropolymer, the structured film comprising a first portion and a second portion, wherein the first portion and the second portion of the structured film have different heights.

In a sixtieth embodiment, the present disclosure provides the structured film of the fifty-ninth embodiment, wherein the structured film comprises upstanding surface structures on a backing.

In a sixty-first embodiment, the present disclosure provides structured film of the sixtieth embodiment, wherein the upstanding surface structures have a dimension of up to one millimeter.

In a sixty-second embodiment, the present disclosure provides the structured film of the sixtieth or sixty-first embodiment, wherein the backing is not continuous.

In a sixty-third embodiment, the present disclosure provides the structured film of any one of the fifty-ninth to sixty-second embodiments, wherein the non-melt-processable fluoropolymer has a melt flow index at 372° C. and five kilogram load of up to 1.0 gram per ten minutes.

In a sixty-fourth embodiment, the present disclosure provides the structured film of any one of the fifty-ninth to sixty-third embodiments, wherein the non-melt-processable fluoropolymer comprises at least one of polytetrafluoroethylene or a copolymer of tetrafluoroethylene and at least one of hexafluoropropylene, chlorotrifluoroethylene, a perfluoroalkyl vinyl ether, or a perfluoroalkyl allyl ether.

In a sixty-fifth embodiment, the present disclosure provides the structured film of any one of the fifty-ninth to sixty-fourth embodiments, wherein the non-melt-processable fluoropolymer further comprises inorganic filler.

In a sixty-sixth embodiment, the present disclosure provides the structured film of any one of the fifty-ninth to sixty-fifth embodiments, wherein the structured film further comprises at least one of water or organic solvent.

In a sixty-seventh embodiment, the present disclosure provides the structured film of any one of the fifty-ninth to sixty-sixth embodiments, wherein the structured film further comprises a polymerized binder material.

In a sixty-eighth embodiment, the present disclosure provides the structured film of any one of the fifty-ninth to sixty-seventh embodiments, wherein non-melt-processable fluoropolymer is comprised in fused fluoropolymer particles.

In a sixty-ninth embodiment, the present disclosure provides the method of any one of the first to fifty-sixth embodiments, wherein the three-dimensional article has a first surface in contact with the radiation-transparent substrate and a second surface opposite the first surface, wherein the first and second surfaces define opposite sides of the three-dimensional article, and wherein the second surface of the three-dimensional article is not in contact with the apparatus when the first surface is in contact with the radiation-transparent substrate.

In a seventieth embodiment, the present disclosure provides the method of any one of the first to fifty-sixth and sixty-ninth embodiments, wherein the thickness of at least one of the first portion or the second portion of the three-dimensional article is a fraction of the thickness of the composition disposed on the surface of the substrate, wherein the fraction is less than 1, and wherein the second surface of the three-dimensional article, described in the sixty-ninth embodiment, is at least partially covered by the composition.

In a seventy-first embodiment, the present disclosure provides the method of any one of the first to fifty-sixth, sixty-ninth, and seventieth embodiments, wherein the composition is contained on at most three sides.

### EXAMPLES

The following specific, but non-limiting, examples will serve to illustrate the present disclosure. Unless otherwise noted, all parts, percentages, ratios, etc. in the examples and the rest of the specification are by weight.

All materials are commercially available, for example from Sigma-Aldrich Chemical Company, St. Louis, Mo., or sources listed in Table 1, below, or known to those skilled in the art, unless otherwise stated or apparent.

TABLE 1
Materials

| Material | Details |
|---|---|
| TF 5135 GZ | Fluoropolymer dispersion, available under the trade designation 3M |
| | “DYNEON PTFE TF 5135 GZ” from 3M Company, St. Paul, MN, |
| | USA |
| Ethoxylated(20) | Available under the trade designation “SR 415” from Sartomer |
| trimethylolpropane | Americas, Exton. PA, USA |
| triacrylate | |
| IRGACURE 819 DW | UV photoinitiator, available from BASF, Florham Park, NJ, USA |
| | under the trade designation “IRGACURE 819 DW” |
| BHT | 2,6-Di-tert-butyl-4-methylphenol, available from Sigma-Aldrich |
| | Company, St. Louis, MO |
| OB-M1 | fluorescent whitener containing 2,5-thiophenediylbis(5-tert-butyl- |
| | 1,3-benzoxazole), available from Mayzo, Inc., Suwanee, GA, USA |
| | under the trade designation “BENETEX OB-M1” |
| Water | De-ionized water |
| 507 Sandblast Stencil | Available under the trade designation “3M ™ Sandblast Stencil - |
| | Hand-Cut Splice Free 507” from 3M Company, St. Paul, MN, USA |
| PET liner | PET based silicone release liner, type RF12N in 5 mil (127 |
| | micrometer) thickness, available from SKC Haas, Seoul, Korea. |

The following abbreviations are used in this section: ° C.=degrees Celsius, mm=millimeters, cm=centimeters, g=grams, nm=nanometer, mL=milliliter; LED=light emitting diode, s=seconds, h=hours, wt %=weight percent, and RPM=revolutions per minute. Abbreviations for materials used in this section, as well as descriptions of the materials, are provided in Table 1.

### Procedure for Exposing Compositions to Radiation

Onto a radiation-transparent substrate, the PET liner, was placed a rectangular piece of 507 Sandblast Stencil with a rectangular area removed from its center. The remaining stencil material formed the walls and the PET liner within the area outlined by the stencil formed the floor of a container. Into the container and onto the siliconized side of the PET liner was poured a resin described for each Example below. Illumination from a 385 nm LED was applied through the floor of the container, i.e. through the PET liner, using a 3D printer, available from Asiga, Anaheim Hills, Calif., USA under the trade designation “PICO PLUS 39.” The 3D printer was modified by removing the build platform. With the build platform removed, the deposition controlled feature height by exposure time to actinic radiation, not by layer-by-layer exposure of controlled heights of polymerizable composition to actinic radiation. Light was directed to selected areas of the floor of the container, for selected lengths of time, by the changing on/off status of elements of the digital light processor element, as indicated for each example below.

### Example 1 (EX-1)

For EX-1, an actinic radiation polymerizable composition was prepared by charging a 100 mL amber glass jar with 40 g “TF 5135GZ” Fluoropolymer Dispersion, 10 g DI Water, 7 g Ethoxylated (20) trimethylolpropane, 0.576 g “IRGACURE 819 DW”, 0.0576 g BIT. The jar was sealed and rotated on a laboratory bench-top roller MX-T6-S at approximately 10 RPM for approximately 2 h.

The composition was exposed to actinic radiation for multiples of 10 s using the procedure described above. The array referred to as 102 in FIG. 1A was exposed to actinic radiation for 10 s, the array referred to as 104 was exposed for 20 s, and the frame referred to as 106 was exposed for 30 s. The formed article was removed from the container and non-polymerized composition was rinsed away and the article was allowed to air dry. The resulting article is shown in the photograph in FIG. 2.

### Example 2 (EX-2)

For EX-2, an actinic radiation polymerizable composition was prepared by charging a 100 mL amber glass jar with 40 g TF 5135GZ Fluoropolymer Dispersion, 10 g DI Water, 7 g Ethoxylated (20) trimethylolpropane, 0.576 g IRGACURE 819 DW, 0.0576 g BHT, and 0.0576 g OB-MI.

The composition was exposed to actinic radiation for multiples of 12 s using the procedure described above. The array referred to as 102 in FIG. 1A was exposed to actinic radiation for 12 s, the array referred to as 104 was exposed for 24 s, and the frame referred to as 106 was exposed for 36 s. The formed article was removed from the container and non-polymerized composition was rinsed away and the article was allowed to air dry. The resulting article is shown in the photograph in FIG. 3.

### Example 3 (EX-3)

For EX-3, the procedure described for EX-2 was followed, with the following exceptions: the article was formed by exposing the composition to actinic radiation in areas indicated by a CAD file generated from the drawing in FIG. 5, the area exposed for 12 s corresponded to the area numbered 730, and the area corresponding to the features numbered 734 were exposed for an additional 20 s. The thickness of the backing 730 was 100 micrometers, and ridges 734 having heights of 200 micrometers and widths of 300 micrometers, 250 micrometers, 200 micrometers, 150 micrometers, and 100 micrometers were spaced 450 micrometers apart on the backing 730.

### Example 4 (EX-4)

For EX-4, the procedure described for EX-2 was followed, with the following exceptions: the article was formed by exposing the composition to actinic radiation in areas indicated by a CAD file generated from the drawing in FIG. 4, the area exposed to actinic radiation for 12 s corresponded to the area numbered 412, and then the feature areas numbered 414 were exposed for an additional 20 s.

This disclosure is not limited to the above-described embodiments but is to be controlled by the limitations set forth in the following claims and any equivalents thereof. This disclosure may be suitably practiced in the absence of any element not specifically disclosed herein.

1. A method of making a three-dimensional article, the method comprising:
obtaining a composition disposed on a surface of a substrate, the composition comprising fluoropolymer particles and a binder material that is polymerizable upon exposure to actinic or particle radiation, wherein the substrate is transparent to the actinic or particle radiation;
irradiating a first portion of the composition through the substrate for a first irradiation dosage; and
irradiating a second portion of the composition through the substrate for a second irradiation dosage, wherein the first portion and the second portion are adjacent to or overlapping with each other, and wherein the first irradiation dosage is different from the second irradiation dosage,
wherein irradiating the first portion of the composition and the second portion of the composition polymerizes the binder material and forms a three-dimensional article having a first portion and a second portion on the surface of the substrate, wherein the first portion of the three-dimensional article has a different thickness in an axis normal to the surface of the substrate than the second portion of the three-dimensional article.

2. The method of claim 1, wherein the first portion of the three-dimensional article has a fraction of the thickness of the first portion of the composition, wherein the second portion of the three-dimensional article has a fraction of the thickness of the second portion of the composition, and wherein at least one of the fraction of the thickness of the first portion of the composition or the fraction of the thickness of the second portion of the composition is less than 1.

3. The method of claim 1, wherein first irradiation dosage and the second irradiation dosage differ in at least one of time or radiation intensity.

4. (canceled)

5. The method of claim 1, further comprising removing at least a portion of the composition comprising the fluoropolymer particles and the binder material in which the binder material is not polymerized after the irradiating.

6. The method of claim 1, further comprising:
moving at least one of the substrate or radiation source; and subsequently
irradiating a third portion of the composition for a third irradiation dosage.

7. The method of claim 1, wherein the binder material comprises at least one of a carbon-carbon double bond, a carbon-carbon triple bond, an epoxide, a silane, or a combination of hydroxyl groups and at least one of ester groups or isocyanate groups.

8. The method of claim 1, wherein the composition further comprises at least one of a photoinitiator, a free-radical inhibitor, or an optical brightener.

9. The method of claim 1, wherein the composition comprises at least one of water or organic solvent, the method further comprising removing the at least one of water or organic solvent.

10. The method of claim 1, wherein the fluoropolymer particles comprise a non-melt-processable fluoropolymer.

11. The method of claim 1, wherein the fluoropolymer particles comprise at least one of a fluorothermoplastic or an amorphous fluoropolymer.

12. The method of claim 1, wherein the fluoropolymer particles are curable, the composition further comprising a curing agent.

13. The method of claim 1, further comprising heating the integral three-dimensional article to at least one of fuse the fluoropolymer particles or thermally degrade the binder material.

14. The method of claim 1, further comprising:
retrieving, from a non-transitory machine readable medium, data representing a model of the three-dimensional article;
executing, by one or more processors interfacing with a manufacturing device, manufacturing instructions using the data; and
generating, by the manufacturing device, the three-dimensional article.

15-16. (canceled)

17. The method of claim 1, wherein the substrate comprises at least one of polyethylene terephthalate, polyethylene naphthalate, polycarbonate, polyimide, cycloolefin, poly(methyl methacrylate), glass, a release liner, or a fluoropolymer.

18. The method of claim 1, wherein irradiating the first portion and irradiating the second portion occur simultaneously.

19. The method of claim 1, wherein at least one of the first irradiation dosage or second irradiation dosage is provided by at least one of ultraviolet light, visible light, X rays, gamma radiation, ion beam radiation, or electron beam radiation.

20. The method of claim 1, wherein at least one of the first irradiation dosage or the second irradiation dosage is provided by a digital light processor with a light emitting diode (LED), a digital light processor with a lamp, a laser scanning device with a laser, a liquid crystal display (LCD) panel with a backlight, a photomask with a lamp, or a photomask with an LED.

21. The method of claim 1, wherein the three-dimensional article is a continuous web.

22. The method of claim 1, wherein the fluoropolymer particles comprise interpolymerized units from at least one partially fluorinated or perfluorinated ethylenically unsaturated monomer represented by formula RCF═CR₂, wherein each R is independently fluoro, chloro, bromo, hydrogen, a fluoroalkyl group having up to 8 carbon atoms and optionally interrupted by one or more oxygen atoms, a fluoroalkoxy group having up to 8 carbon atoms and optionally interrupted by one or more oxygen atoms, alkyl having up to 10 carbon atoms, alkoxy having up to 8 carbon atoms, or aryl having up to 8 carbon atoms.

23. The method of claim 1, wherein in the first portion and the second portion of the three-dimensional article, the binder material in contact with the substrate is polymerized.
